(19) United States
(12) Patent Application Publication
(10) Pub. No.: US 2023/0239943 A1
(43) Pub. Date: Jul. 27, 2023

(54) LAYER 2 RELAY INITIAL CONFIGURATION

(71) Applicant: QUALCOMM Incorporated, San Diego, CA (US)

(72) Inventors: Karthika PALADUGU, San Diego, CA (US); Hong CHENG, Basking Ridge, NJ (US); Peng CHENG, Beijing (CN)

(21) Appl. No.: 18/001,825

(22) PCT Filed: Aug. 20, 2021
(86) PCT No.: PCT/CN2021/113718

§ 371 Date: Dec. 14, 2022

(30) Foreign Application Priority Data
Aug. 23, 2020 (WO) PCT/CN2020/110670

(51) Int. Cl. H04W 76/14; H04W 8/22; H04W 60/04

(52) U.S. Cl. CPC H04W 76/14; H04W 8/22; H04W 60/04; H04W 92/18

(57) ABSTRACT

Various aspects of the present disclosure generally relate to wireless communication. In some aspects, a relay user equipment (UE) may initiate a connection with a network entity. The relay UE may receive a layer 2 relay initial configuration based at least in part on initiating the connection. Numerous other aspects are provided.

### CROSS-REFERENCE TO RELATED APPLICATION

This Patent Application claims priority to International Patent Application No. PCT/CN2020/110670, filed on Aug. 23, 2020, entitled “LAYER 2 RELAY INITIAL CONFIGURATION,” and assigned to the assignee hereof. The disclosure of the prior Application is considered part of and is incorporated by reference into this Patent Application.

### INTRODUCTION

Aspects of the present disclosure generally relate to wireless communication and to techniques and apparatuses for configuring a relay user equipment (UE).

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of UEs. A UE may communicate with a BS via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication performed by a network entity includes performing a network connection setup procedure for a user equipment (UE). The method includes transmitting, during the network connection setup procedure, an indication that the has a capability to operate as a layer 2 relay UE.

In some aspects, a network entity for wireless communication includes a memory and one or more processors coupled to the memory. The memory and the one or more processors are configured to perform a network connection setup procedure for a UE. The memory and the one or more processors are configured to transmit, during the network connection setup procedure, an indication that the has a capability to operate as a layer 2 relay UE.

In some aspects, a non-transitory computer-readable medium storing a set of instructions for wireless communication includes one or more instructions that, when executed by one or more processors of a network entity, cause the network entity to perform a network connection setup procedure for a UE. The one or more instructions, when executed by the one or more processors of the network entity, cause the network entity to transmit, during the network connection setup procedure, an indication that the has a capability to operate as a layer 2 relay UE.

In some aspects, an apparatus for wireless communication includes means for performing a network connection setup procedure for a UE. The apparatus includes means for transmitting, during the network connection setup procedure, an indication that the has a capability to operate as a layer 2 relay UE.

In some aspects, a method of wireless communication performed by a first UE includes initiating a connection with a network entity. The method includes receiving a layer 2 relay initial configuration based at least in part on initiating the connection.

In some aspects, a method of wireless communication performed by a network entity includes receiving an indication that a UE has a capability to operate as a layer 2 relay UE. The method includes transmitting a layer 2 relay initial configuration to the UE based at least in part on receiving the indication.

In some aspects, a method of wireless communication performed by a first UE includes receiving a request to establish a layer 2 relay service from a second UE; and transmitting a layer 2 relay initial configuration to the second UE based at least in part on receiving the request.

In some aspects, a method of wireless communication performed by a first UE includes transmitting a request to establish a layer 2 relay service to a second UE. The method includes receiving a layer 2 relay initial configuration from the second UE based at least in part on transmitting the request.

In some aspects, a first UE for wireless communication includes a memory and one or more processors coupled to the memory. The memory and the one or more processors are configured to initiate a connection with a network entity. The memory and the one or more processors are configured to receive a layer 2 relay initial configuration based at least in part on initiating the connection.

In some aspects, a network entity for wireless communication includes a memory and one or more processors coupled to the memory. The memory and the one or more processors are configured to receive an indication that a UE has a capability to operate as a layer 2 relay UE. The memory and the one or more processors are configured to transmit a layer 2 relay initial configuration to the UE based at least in part on receiving the indication.

In some aspects, a first UE for wireless communication includes a memory and one or more processors coupled to the memory. The memory and the one or more processors are configured to receive a request to establish a layer 2 relay service from a second UE. The memory and the one or more processors are configured to transmit a layer 2 relay initial configuration to the second UE based at least in part on receiving the request.

In some aspects, a first UE for wireless communication includes a memory and one or more processors coupled to the memory. The memory and the one or more processors are configured to transmit a request to establish a layer 2 relay service to a second UE. The memory and the one or more processors are configured to receive a layer 2 relay initial configuration from the second UE based at least in part on transmitting the request.

In some aspects, a non-transitory computer-readable medium storing a set of instructions for wireless communication includes one or more instructions that, when executed by one or more processors of a first UE, cause the first UE to initiate a connection with a network entity. The one or more instructions, when executed by the one or more processors of the first UE, cause the first UE to receive a layer 2 relay initial configuration based at least in part on initiating the connection.

In some aspects, a non-transitory computer-readable medium storing a set of instructions for wireless communication includes one or more instructions that, when executed by one or more processors of a network entity, cause the network entity to receive an indication that a UE has a capability to operate as a layer 2 relay UE. The one or more instructions, when executed by the one or more processors of the network entity, cause the network entity to transmit a layer 2 relay initial configuration to the UE based at least in part on receiving the indication.

In some aspects, a non-transitory computer-readable medium storing a set of instructions for wireless communication includes one or more instructions that, when executed by one or more processors of a first UE, cause the first UE to receive a request to establish a layer 2 relay service from a second UE. The one or more instructions, when executed by the one or more processors of the first UE, cause the first UE to transmit a layer 2 relay initial configuration to the second UE based at least in part on receiving the request.

In some aspects, a non-transitory computer-readable medium storing a set of instructions for wireless communication includes one or more instructions that, when executed by one or more processors of a first UE, cause the first UE to transmit a request to establish a layer 2 relay service to a second UE. The one or more instructions, when executed by one or more processors of a first UE, cause the first UE to receive a layer 2 relay initial configuration from the second UE based at least in part on transmitting the request.

In some aspects, an apparatus for wireless communication includes means for initiating a connection with a network entity. The apparatus includes means for receiving a layer 2 relay initial configuration based at least in part on initiating the connection.

In some aspects, an apparatus for wireless communication includes means for receiving an indication that a UE has a capability to operate as a layer 2 relay UE. The apparatus includes means for transmitting a layer 2 relay initial configuration to the UE based at least in part on receiving the indication.

In some aspects, an apparatus for wireless communication includes means for receiving a request to establish a layer 2 relay service from a UE. The apparatus includes means for transmitting a layer 2 relay initial configuration to the UE based at least in part on receiving the request.

In some aspects, an apparatus for wireless communication includes means for transmitting a request to establish a layer 2 relay service to a UE. The apparatus includes means for receiving a layer 2 relay initial configuration from the UE based at least in part on transmitting the request.

Aspects generally include a method, apparatus, system, computer program product, non-transitory computer-readable medium, user equipment, base station, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIGS. 1A and 1B are diagrams illustrating an example of a wireless network, in accordance with the present disclosure.

FIG. 2 is a diagram illustrating an example of a base station in communication with a relay user equipment (UE) in a wireless network, which is in communication with a remote UE, in accordance with the present disclosure.

FIG. 3 is a diagram illustrating an example of a control-plane protocol architecture for a layer 2 UE-to-network relay, in accordance with the present disclosure.

FIG. 4 is a diagram illustrating an example of a user-plane protocol architecture for a layer 2 UE-to-network relay, in accordance with the present disclosure.

FIG. 5 is a diagram illustrating an example of a control-plane protocol architecture for a layer 2 light UE-to-network relay, in accordance with the present disclosure.

FIG. 6 is a diagram illustrating an example of a user-plane protocol architecture for a layer 2 light UE-to-network relay, in accordance with the present disclosure.

FIG. 7 is a diagram illustrating an example of establishing a layer 2 relay connection for a layer 2 light UE-to-network relay, in accordance with the present disclosure.

FIG. 8 is a diagram illustrating an example of establishing a layer 2 relay connection for a layer 2 UE-to-network relay, in accordance with the present disclosure.

FIGS. 9 and 10 are diagrams illustrating examples associated with a layer 2 relay initial configuration, in accordance with the present disclosure.

FIGS. 11-14 are diagrams illustrating example processes associated with a layer 2 relay initial configuration, in accordance with the present disclosure.

FIG. 15 is a block diagram of an example apparatus for wireless communication, in accordance with the present disclosure.

FIG. 16 is a diagram illustrating an example of a hardware implementation for an apparatus employing a processing system, in accordance with the present disclosure.

FIG. 17 is a diagram illustrating an example of an implementation of code and circuitry for an apparatus, in accordance with the present disclosure.

FIG. 18 is a block diagram of an example apparatus for wireless communication, in accordance with the present disclosure.

FIG. 19 is a diagram illustrating an example of a hardware implementation for an apparatus employing a processing system, in accordance with the present disclosure.

FIG. 20 is a diagram illustrating an example of an implementation of code and circuitry for an apparatus, in accordance with the present disclosure.

FIG. 21 is a block diagram of an example apparatus for wireless communication, in accordance with the present disclosure.

FIG. 22 is a diagram illustrating an example of a hardware implementation for an apparatus employing a processing system, in accordance with the present disclosure.

FIG. 23 is a diagram illustrating an example of an implementation of code and circuitry for an apparatus, in accordance with the present disclosure.

FIG. 24 is a diagram illustrating an example process associated with a UE capability signaling, in accordance with the present disclosure.

FIG. 25 is a block diagram of an example apparatus for wireless communication, in accordance with the present disclosure.

FIG. 26 is a diagram illustrating an example of a hardware implementation for an apparatus employing a processing system, in accordance with the present disclosure.

FIG. 27 is a diagram illustrating an example of an implementation of code and circuitry for an apparatus, in accordance with the present disclosure.

### DETAILED DESCRIPTION

In a wireless network, a user equipment (UE) may operate as a UE-to-network relay for another UE. In these cases, the UE performing the relay function may be referred to as a relay UE, and the UE for which the relay UE provides the relay function may be referred to as a remote UE. In some cases, the relay UE may operate as a UE-to-network relay (e.g., a UE that relays network traffic between a wireless network and another UE) for the remote UE in examples where the remote UE is outside of a coverage area of a base station for which the relay UE is providing a relay function, where a blockage or another type of obstruction causes a drop in coverage for remote UE, where the remote UE may obtain decreased speed and increased bandwidth through the relay UE, and/or the like. In some cases, the relay UE may operate as a layer 2 relay. In these cases, the relay UE may handle physical layer processing between the remote UE and a base station, as well as layer 2 processing. Layer 2 processing may include medium access control (MAC) layer processing, radio link control (RLC) processing, and/or processing of other layer 2 functions. In some cases, a configuration for a relay UE may, in some communication scenarios, decrease reliability for a connection between a remote UE and a base station through the relay UE, may increase latency on the connection, and/or may decrease throughput on the connection.

Some aspects described herein provide techniques and apparatuses for a layer 2 relay initial configuration. The layer 2 relay initial configuration includes a configuration that assists a relay UE (and/or a remote UE that connects to the relay UE for a layer 2 relay service, for a layer 2 light relay service, and/or the like) to send and receive initial radio resource control (RRC) messages to and from the NG-RAN. To establish a RRC connection between a remote UE and a base station via a relay UE, the relay UE, and the remote UE may be provided with a layer 2 relay initial configuration that may be used to send and receive initial remote UE RRC messages to and from the base station. The layer 2 relay initial configuration may provide RLC, MAC, and physical layer configurations for the remote UE and the relay UE. The layer 2 relay initial configuration may be dynamic, in that the RLC, MAC, and physical layer configurations provided therein may be configured for particular types of signaling radio bearers (SRBs) for the Uu (or access link) logical channels between the relay UE and the base station such as an SRBO. In this way, different types of SRBs may be configured for the remote UE and the relay UE using the layer 2 relay initial configuration which may increase reliability for the connection between the remote UE and the base station through the relay UE, may decrease latency on the connection, may increase throughput on the connection, may enable dynamic relay configuration, and/or the like.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

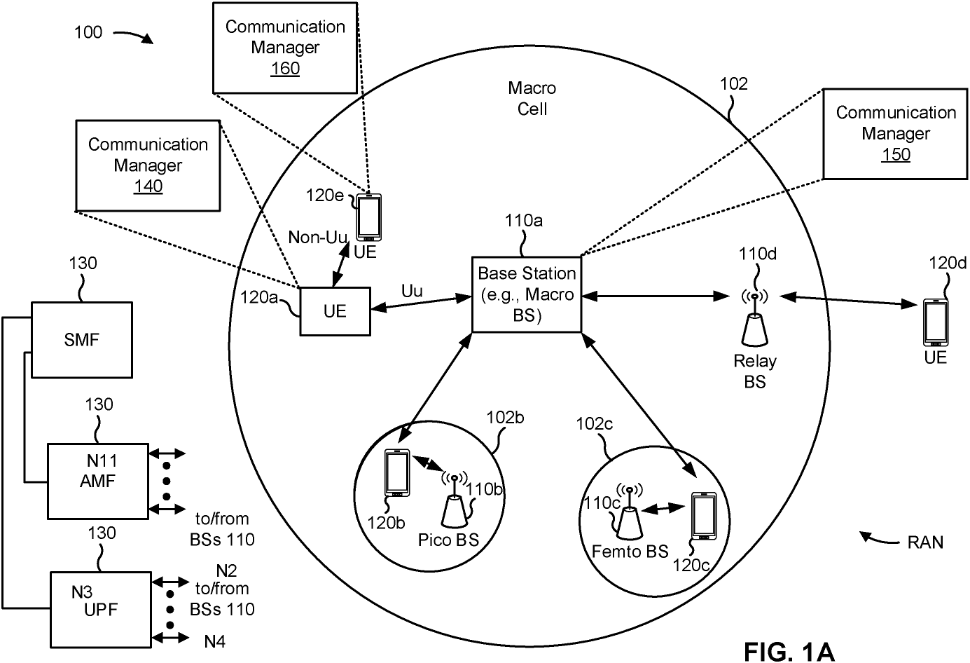

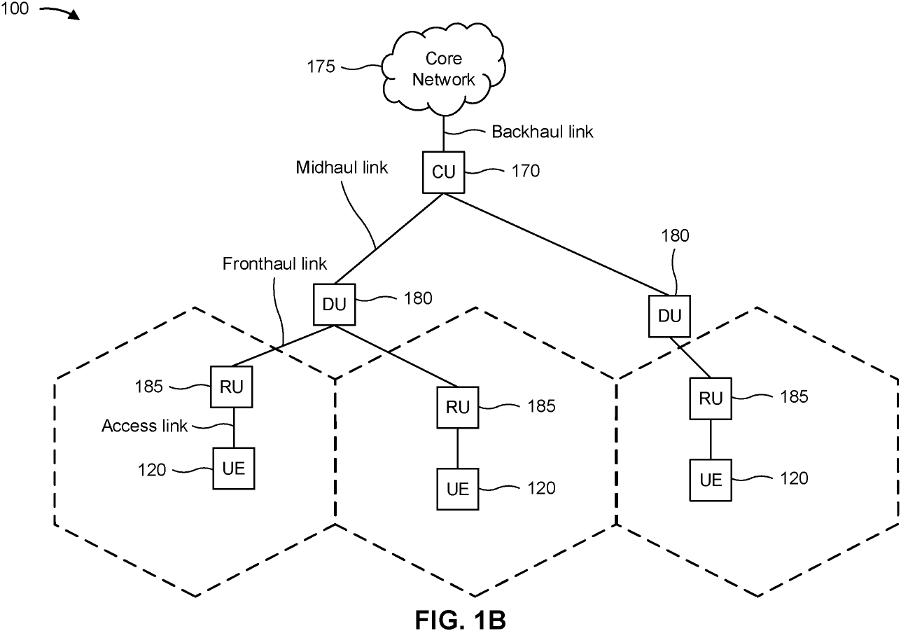

FIGS. 1A and 1B are diagrams illustrating an example of a wireless network 100, in accordance with the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with UEs and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1A, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some examples, a cell may not necessarily be stationary, and the geographic area of the cell may move according to the location of a mobile BS. In some examples, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1A, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

Network controller 130 may include, for example, one or more devices in a core network such as an evolved packet core (EPC), a 5G NR core (NGC), or another type of core network. Network controller 130 may communicate with a radio access network (RAN) that includes the base stations 110 of the wireless network 100 via communication unit 294. The RAN may include an LTE RAN (e.g., an evolved universal mobile telecommunications system terrestrial radio access (E-UTRA)), a 5G NR RAN (e.g., an NG-RAN), or another type of RAN.

The core network functions of the core network may include various 5G NR core network functions, such as an access and mobility management function (AMF) implemented by one or more network controllers 130, a session management function (SMF) implemented by one or more network controllers 130, a user plane function (UPF) implemented by one or more network controllers 130, and/or the like. The core network functions of the core network may communicate on a core network interface such as an N11 interface between the AMF and the SMF, an N3 interface between the AMF and the UPF, and/or the like.

The AMF may manage authentication, activation, deactivation, and/or mobility functions associated for UEs in the wireless network 100. The AMF may facilitate the selection of a gateway (e.g., a serving gateway, a packet data network gateway, a UPF, and/or the like) to serve traffic to and/or from the UEs in the wireless network 100. In some aspects, the AMF device may perform operations associated with handover for the UEs in the wireless network 100. The SMF may be responsible for managing communication sessions associated with the UEs in the wireless network 100. The UPF may function as a session anchor and/or gateway for the UEs in the wireless network 100, may forward traffic (e. g., user plane traffic, application traffic, and/ or the like) between the UEs in the wireless network and application servers and/or other UPFs, and/or the like.

Base stations 110 of the RAN and one or more core network functions implemented by one or more network controllers 130 in the core network may communicate on a core network interface. For example, the base stations 110 may communicate with the AMF on an N2 interface or another type of core network interface. As another example, the base stations 110 may communicate with a UPF on an N4 interface.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In some aspects, the UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz - 7.125 GHz) and FR2 (24.25 GHz - 52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz - 300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz - 24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz - 71 GHz), FR4 (52.6 GHz - 114.25 GHz), and FR5 (114.25 GHz - 300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE 120 may operate as a UE-to-network relay for another UE 120 in the wireless network 100. For example, and as illustrated in FIG. 1A, UE 120a may operate as a UE-to-network relay for UE 120e. In these examples, UE 120a may communicate with a base station 110 on an access link (e.g., a Uu link) and may communicate with UE 120e on a non-Uu link such as a sidelink (e.g., a PC5 link), a WiFi link, a WiFi direct (WiFi-D) link, a Bluetooth (BT), a Bluetooth low energy (BTLE), and/or another type of local connection to relay communications between the UE 120e and the base station 110. In some aspects, UE 120a may operate as a UE-to-network relay for UE 120e in examples where UE 120e is outside of a coverage area of a base station 110 being served by UE 120a, where a blockage or another type of obstruction causes a drop in coverage for UE 120e, where UE 120e may obtain decreased speed and increased bandwidth through UE 120a, and/or the like. In some aspects, UE 120a may operate a layer 2 relay. In these cases UE 120a may handle physical layer processing between UE 120e and a base station 110, as well as layer 2 processing. Layer 2 processing may include MAC layer processing, RLC processing, and/or other layer 2 functions.

As shown in FIG. 1A, a UE 120 (e.g., a relay UE such as UE 120a) may include a communication manager 140. As described in more detail elsewhere herein, the communication manager 140 may initiate a connection with a network entity such as base station 110a, may receive a layer 2 relay initial configuration based at least in part on initiating the connection, and/or the like. As described in more detail elsewhere herein, the communication manager 140 may receive a request to establish a layer 2 relay service from a remote UE such as UE 120e, may transmit a layer 2 relay initial configuration to the remote UE based at least in part on receiving the request, and/or the like. Additionally, or alternatively, the communication manager 140 may perform one or more other operations described herein.

In some aspects, a base station 110 may include a communication manager 150. As described in more detail elsewhere herein, the communication manager 150 may receive an indication that a UE 120 (e.g., UE 120a) has a capability to operate as a layer 2 relay UE, may transmit a layer 2 relay initial configuration to the UE 120 based at least in part on receiving the indication, and/or the like. Additionally, or alternatively, the communication manager 150 may perform one or more other operations described herein.

In some aspects, a UE 120 (e.g., a remote UE such as UE 120e) may include a communication manager 160. As described in more detail elsewhere herein, the communication manager 160 may transmit a request to establish a layer 2 relay service to a relay UE such as UE 120a, may receive a layer 2 relay initial configuration from the relay UE based at least in part on transmitting the request, and/or the like. Additionally, or alternatively, the communication manager 150 may perform one or more other operations described herein.

FIG. 1B is a diagram illustrating an example of a disaggregated RAN, distributed RAN, or open RAN (O-RAN) architecture, which may be implemented in at least a portion of the wireless network 100. As shown in FIG. 1B, the O-RAN architecture may include a control unit (CU) 170 that communicates with a core network 175 via a backhaul link. The core network 175 may include a plurality of network controllers 130 (e.g., network entities) that implement core network functions, such as described above in FIG. 1A and/or elsewhere herein. Furthermore, the CU 170 may communicate with one or more distributed units or disaggregated units (DUs) 180 via respective midhaul links. The DUs 180 may each communicate with one or more radio units (RUs) 185 via respective fronthaul links, and the RUs 185 may each communicate with respective UEs 120 via radio frequency (RF) access links. The DUs 180 and the RUs 185 may also be referred to as O-RAN DUs (O-DUs) 180 and O-RAN RUs (O-RUs) 180, respectively.

In some aspects, the DUs 180 and the RUs 185 may be implemented according to a functional split architecture in which functionality of a base station 110 (e.g., an eNB or a gNB) is provided by a DU 180 and one or more RUs 185 that communicate over a fronthaul link. Accordingly, as described herein, a base station 110 may include a DU 180 and one or more RUs 185 that may be co-located or geographically distributed. In some aspects, the DU 180 and the associated RU(s) 185 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 180 may correspond to a logical unit that includes one or more base station functions to control the operation of one or more RUs 185. For example, in some aspects, the DU 180 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 170. The RU(s) 185 controlled by a DU 180 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 185 handle all over the air (OTA) communication with a UE 120, and real-time and non-real-time aspects of control and user plane communication with the RU(s) 185 are controlled by the corresponding DU 180, which enables the DU(s) 180 and the CU 170 to be implemented in a cloud-based RAN architecture.

As indicated above, FIGS. 1A and 1B are provided merely as examples. Other examples may differ from what is described with regard to FIGS. 1A and 1B.

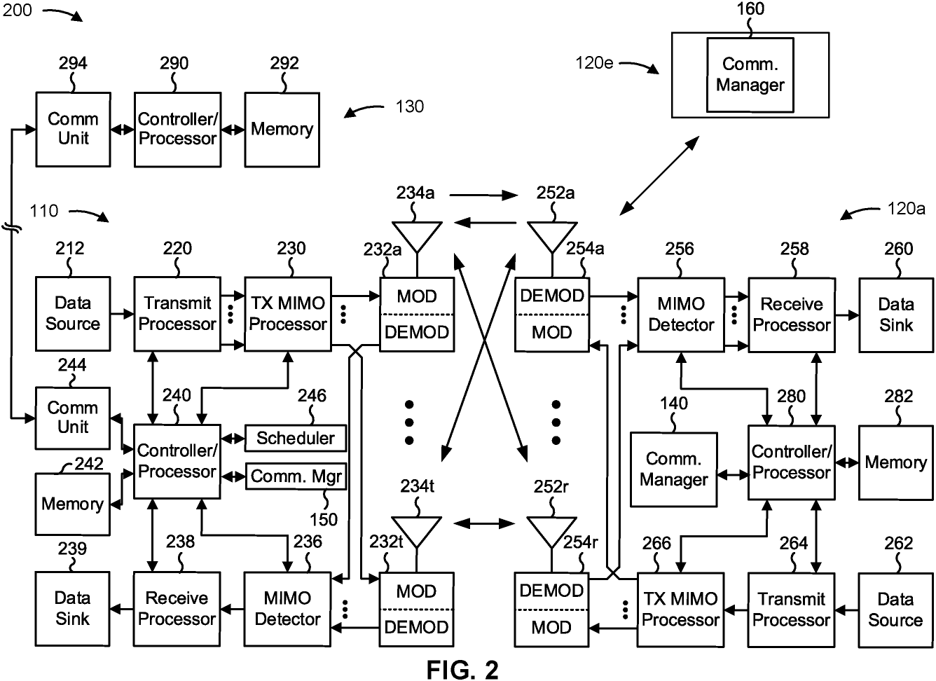

FIG. 2 is a diagram illustrating an example 200 of a base station 110 in communication with a relay UE 120 (e.g., UE 120a) in a wireless network 100, which is in communication with a remote UE 120 (e.g., UE 120e), in accordance with the present disclosure. Base station 110 may be equipped with T antennas 234a through 234t, and UE 120a and UE 120e may each be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to Tmodulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120a and UE 120e, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for each of the UE 120a and the UE 120e to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), CQI, and/or the like. In some aspects, one or more components of UE 120a and/or the UE 120e may be included in a housing.

Network controller 130 may include communication unit 294, controller/processor 290, and memory 292. Network controller 130 may include, for example, one or more devices in a core network that implement one or more of the core network functions described above in FIG. 1A, and/or one or more components included in the core network 175 of FIG. 1B. Network controller 130 may communicate with base station 110 via communication unit 294.

On the uplink, at UE 120a and UE 120e, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120a and the UE 120e each include a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein.

At base station 110, the uplink signals from UE 120a and/or UE 120e (as well as other UEs) may be received by antennas 234, processed by demodulators 232, detected by a MIMO detector 236 if applicable, and further processed by a receive processor 238 to obtain decoded data and control information sent by UE 120a and/or UE 120e. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 (e.g., UE 120a, UE 120e, and/or the like) for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein.

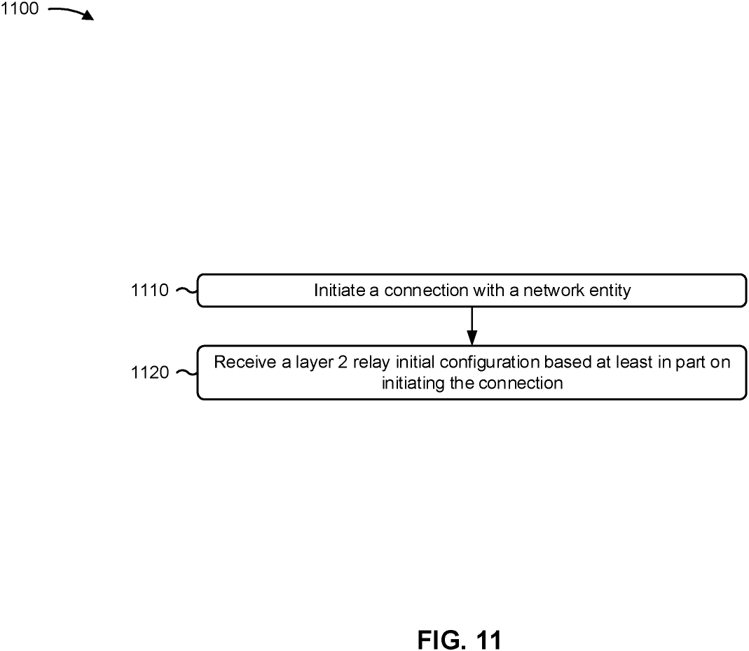

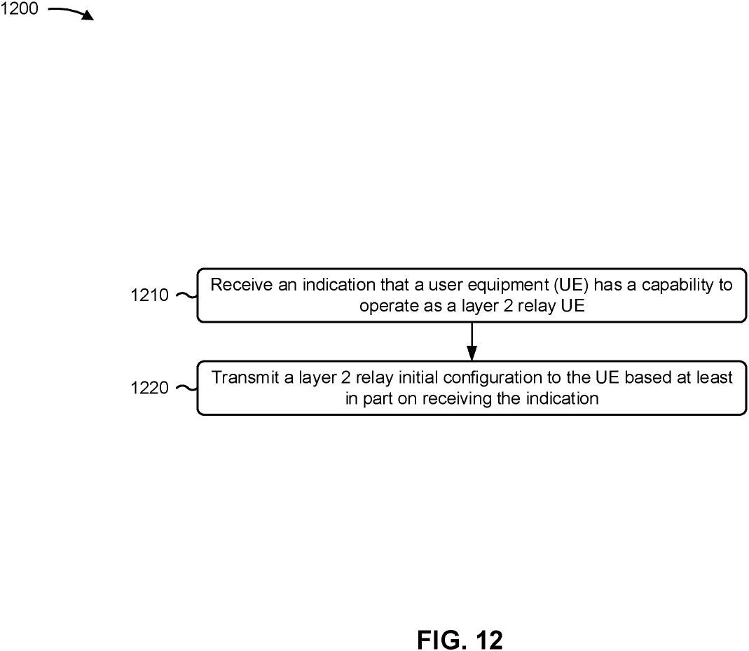

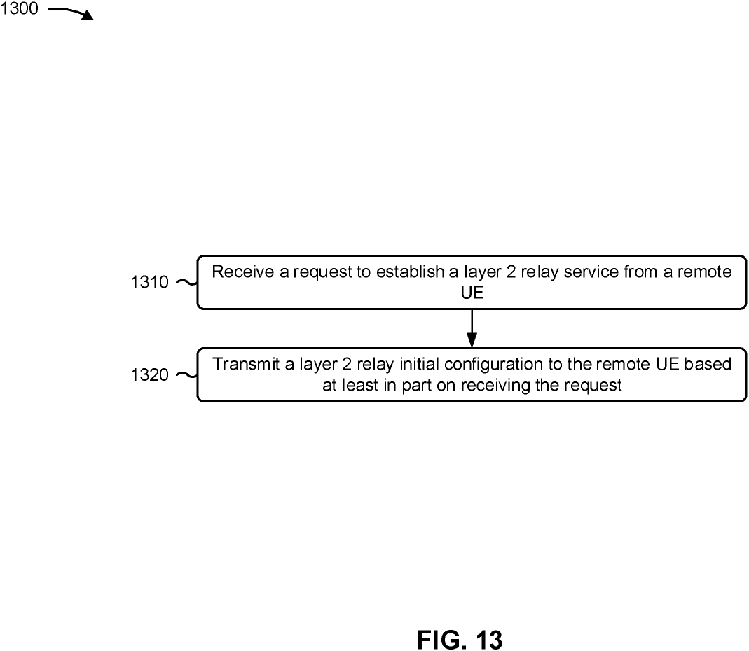

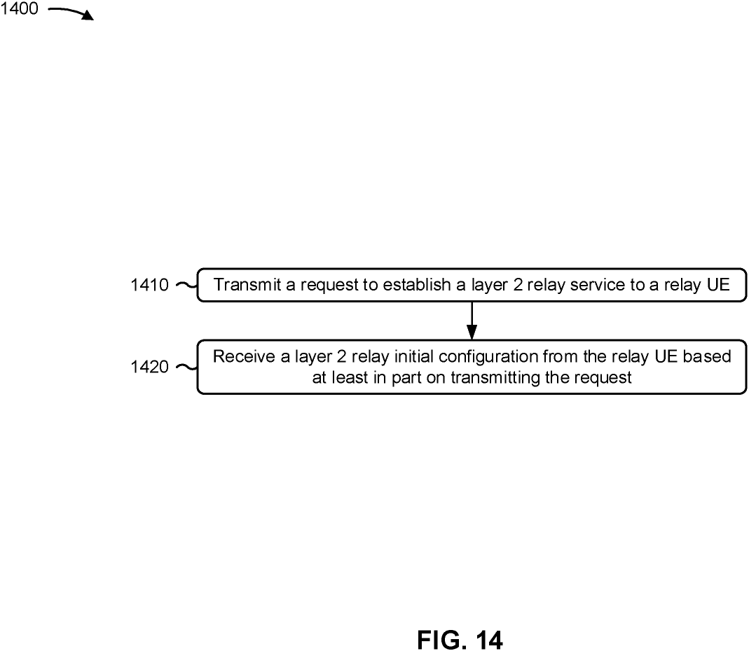

Controller/processor 240 of base station 110, controller/processor 280 of UE 120a and UE 120e, and/or any other component(s) of FIG. 2 may perform one or more techniques associated with a layer 2 relay initial configuration, as described in more detail elsewhere herein. For example, controller/processor 240 of base station 110, controller/processor 280 of UE 120a and UE 120e, and/or any other component(s) of FIG. 2 may perform or direct operations of, for example, process 1100 of FIG. 11, process 1200 of FIG. 12, process 1300 of FIG. 13, process 1400 of FIG. 14, and/or other processes as described herein. Memories 242 and 282 may store data and program codes for base station 110 and the UEs 120a and 120e, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120a and/or UE 120e, may cause the one or more processors, the UE 120a, the UE 120e, and/or the base station 110 to perform or direct operations of, for example, process 1100 of FIG. 11, process 1200 of FIG. 12, process 1300 of FIG. 13, process 1400 of FIG. 14, and/or other processes as described herein. In some aspects, executing instructions may include running the instructions, converting the instructions, compiling the instructions, interpreting the instructions, and/or the like.

In some aspects, the UE 120a may include means for initiating a connection with a network entity (e.g., base station 110), means for receiving a layer 2 relay initial configuration based at least in part on initiating the connection, and/or the like. In some aspects, the UE 120a may include means for receiving a request to establish a layer 2 relay service from a remote UE (e.g., UE 120e), means for transmitting a layer 2 relay initial configuration to the remote UE based at least in part on receiving the request, and/or the like. Additionally, or alternatively, the UE 120a may include means for performing one or more other operations described herein. In some aspects, such means may include the communication manager 140. Additionally, or alternatively, such means may include one or more other components of the UE 120a described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, the base station 110 may include means for receiving an indication that a UE (e.g., UE 120a) has a capability to operate as a layer 2 relay UE, means for transmitting a layer 2 relay initial configuration to the UE based at least in part on receiving the indication, and/or the like. Additionally, or alternatively, the base station 110 may include means for performing one or more other operations described herein. In some aspects, such means may include the communication manager 150. In some aspects, such means may include one or more other components of the base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

In some aspects, the UE 120e may include means for transmitting a request to establish a layer 2 relay service to a relay UE (e.g., UE 120a), means for receiving a layer 2 relay initial configuration from the relay UE based at least in part on transmitting the request, and/or the like. Additionally, or alternatively, the UE 120e may include means for performing one or more other operations described herein. In some aspects, such means may include the communication manager 160. Additionally, or alternatively, such means may include one or more other components of the UE 120e described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, a network controller 130 includes means for performing a network connection setup procedure for a UE 120, means for transmitting, during the network connection setup procedure, an indication that the UE 120 has a capability to operate as a layer 2 relay UE, and/or the like. In some aspects, such means may include one or more other components of the network controller 130 described in connection with FIG. 2, such as controller/processor 290, memory 292, communication unit 294, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided merely as an example. Other examples may differ from what is described with regard to FIG. 2.

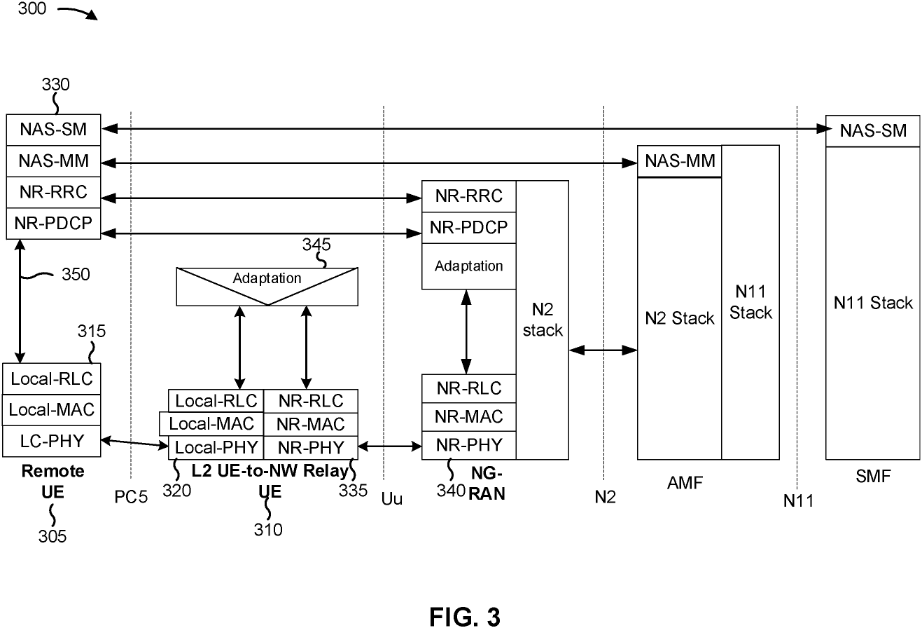

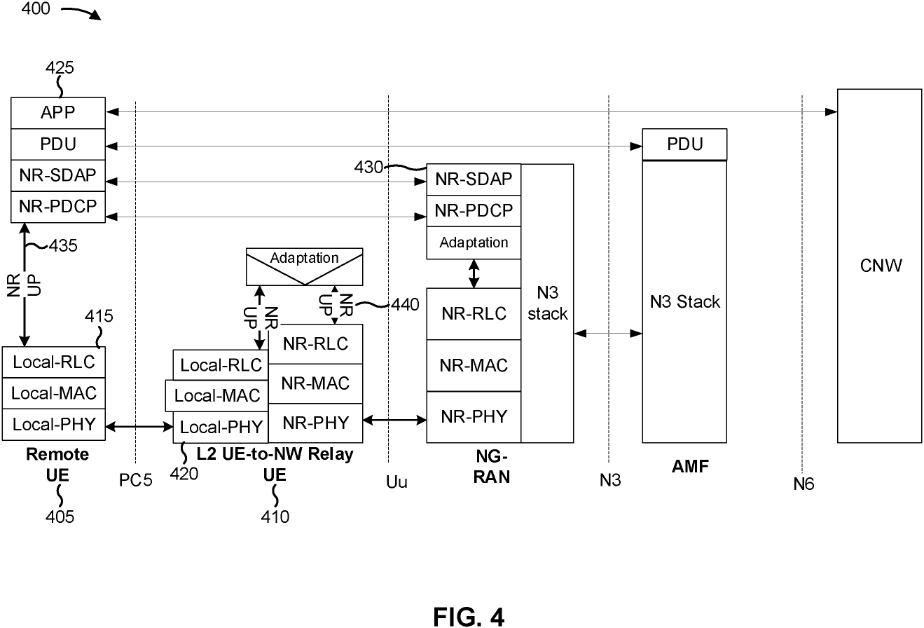

FIG. 3 is a diagram illustrating an example of a control-plane protocol architecture 300 for a Layer 2 UE-to-network relay (also referred to herein as a relay UE), in accordance with the present disclosure. FIG. 4 is a diagram illustrating an example of a user-plane protocol architecture 400 for a Layer 2 UE-to-network relay, in accordance with the present disclosure. For example, the control-plane protocol architecture 300 and the user-plane protocol architecture 400 may correspond to a remote UE (e.g., UE 120e) shown by reference numbers 305 and 405 and a relay UE (e.g., UE 120a) shown by reference numbers 310 and 410.

As shown in FIG. 3, in the control-plane, there may be a local interface (e.g., a sidelink interface, a PC5 interface, a WiFi interface, a WiFi-D interface, a BT interface, a BTLE interface, and/or another type of local interface) between the remote UE and the relay UE, a Uu interface (e.g., an access link interface) between the relay UE and a next generation radio access network (NG-RAN, also referred to herein as a 5G access network (5G-AN)), an N2 interface between the NG-RAN and AMF (e.g., which may be implemented by a network controller 130) of the control-plane protocol architecture 300, and an N11 interface between the AMF and an SMF (e.g., which may be implemented by a network controller 130).

As shown in FIG. 4, there may be an N3 interface between the NG-RAN and a UPF (e.g., which may be implemented by a network controller 130) of the user-plane protocol architecture 400, and an N6 interface between the UPF and a core network (CN).

As further shown, the remote UE and the relay UE may be associated with respective local protocol stacks 315/320 and 415/420 (e.g., sidelink protocol stacks, PC5 protocol stacks, WiFi protocol stacks, WiFi-D protocol stacks, BT protocol stacks, BTLE protocol stacks, and/or another type of local protocol stacks), enabling communication on the local interface between the remote UE and the relay UE. The local protocol stack may include a local RLC component, a local MAC component, a local physical (PHY) component, and/or the like. Communications between the remote UE and the relay UE using the local interface may be referred to as sidelink communications or local communications. The respective local protocol stacks may be associated with one or more of PC5-S entities, PC5- RRC entities, PC5-PDCP entities, local connection entities, sidelink entities, and/or the like. The PC5-S entity may manage a sidelink signaling interface, such as a PC5-S interface. A UE that includes a PC5-S entity and/or a PC5-RRC entity may handle control signaling and configuration of a sidelink connection with another UE, such as the connection used for relaying between the remote UE and the relay UE. In some aspects, the PC5 protocol stacks 315/320 and 415/420 may not include PC5-S entities or PC5-RRC entities. In such a case, the NG-RAN may handle control signaling and configuration of the sidelink connection

As shown by reference number 330 of FIG. 3, the remote UE is associated with a non-access stratum (NAS) stack, which includes an NAS session management (NAS-SM) component, an NAS mobility management (NAS-MM) component, and one or more radio access components (e.g., an NR-RRC component and an NR-PDCP component). As shown by reference number 335 of FIG. 3, the relay UE is associated with a radio access stack, including an NR-RLC component, an NR-MAC component, and an NR-PHY component. Furthermore, the NG-RAN is associated with a radio access interface stack shown by reference number 340, which includes an NR-RLC component, an NR-MAC component, an NR-PHY component, an NR-RRC entity, and an NR-PDCP entity.

The adaptation layer entity of the relay UE, shown by reference number 345, may handle relaying, bearer mapping, remote UE identification from the remote UE to the network or from the network to the remote UE. As used herein, “the network” may refer to any one or more of the NG-RAN, the AMF, the SMF, the UPF, or the CN. In some aspects, the adaptation layer is referred to as an adaptation layer entity. In some aspects, the adaptation layer entity may be a separate entity between a radio link control entity and a packet data convergence entity. In some aspects, the adaptation layer entity may be logically part of the packet data convergence entity or the radio link control entity

Communication between stacks of the remote UE is indicated by the lines shown by reference number 350. The line between the NR-PDCP entity and the PC5-RLC entity indicates how a message (e.g., an NR RRC message generated by the radio access protocol stack) that is not encapsulated in a sidelink signaling container, such as a PC5-S container, might be communicated from the radio access stack to the local stack for transmission via the sidelink interface, or how a message that is not encapsulated in a PC5-S container might be communicated from the local stack to the radio access stack after being received via the sidelink interface. Note that the line between the NR-PDCP entity and the PC5-RLC entity does not involve the PC5-S or PC5-PDCP entities, meaning that the PC5-S and PC5-PDCP entities do not handle such messages. A similar line is shown to indicate communication between the adaptation layer and the PC5-RLC entity that bypasses the PC5-S and PC5-PDCP entities of the relay UE.

In some aspects, the remote UE may further include a PC5-S or a PC5-RRC entity. In these examples, another communication line between the NR-PDCP entity and the PC5-S or PC5-RRC entity may be used to communicate a message (e.g., an NR RRC message generated by the radio access protocol stack) that is encapsulated in a PC5-S container from the radio access stack to the local stack for transmission via the sidelink interface, or to communicate a message that is encapsulated in a PC5-S container might from the local stack to the radio access stack after being received via the sidelink interface. Note that the line between the NR-PDCP entity and the PC5-RLC entity involves the PC5-S entity, meaning that the PC5-S entity may handle such messages.

As shown by reference number 425 of FIG. 4, the remote UE is associated with a user-plane protocol stack, which may include an application (APP) component, a protocol data unit (PDU) component, an NR-SDAP component, and an NR-PDCP component. Furthermore, the NG-RAN is associated with user-plane components shown by reference number 430, which include an NR-SDAP component and an NR-PDCP component. The NR-SDAP component and the NR-PDCP component may be referred to herein as radio access entities.

NR user-plane traffic (shown by a line indicated by “NR UP”) may be transported between the NR-PDCP entity and the PC5-RLC component, as shown by reference number 435. Such NR user-plane traffic may be transported to the relay UE via one or more bearers, such as a data radio bearer (DRB) or SRB established. As shown by reference number 440, the NR user-plane traffic may be provided from the PC5 stack of the relay UE to the adaptation component, and from the adaptation component to the radio access stack of the relay UE. The radio access stack of the relay UE may provide the NR user-plane traffic to the NG-RAN (not shown). Sidelink communications, such as PC5 control messaging and/or the like, may occur between the PC5-SDAP components of the remote UE and the relay UE.

As indicated above, FIGS. 3 and 4 are provided as examples. Other examples may differ from what is described with respect to FIGS. 3 and 4.

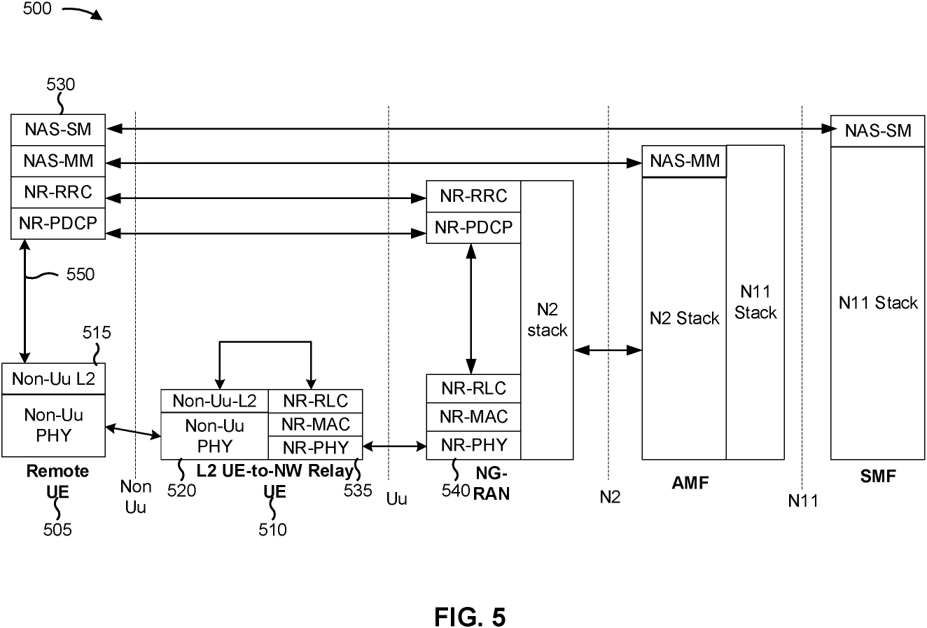

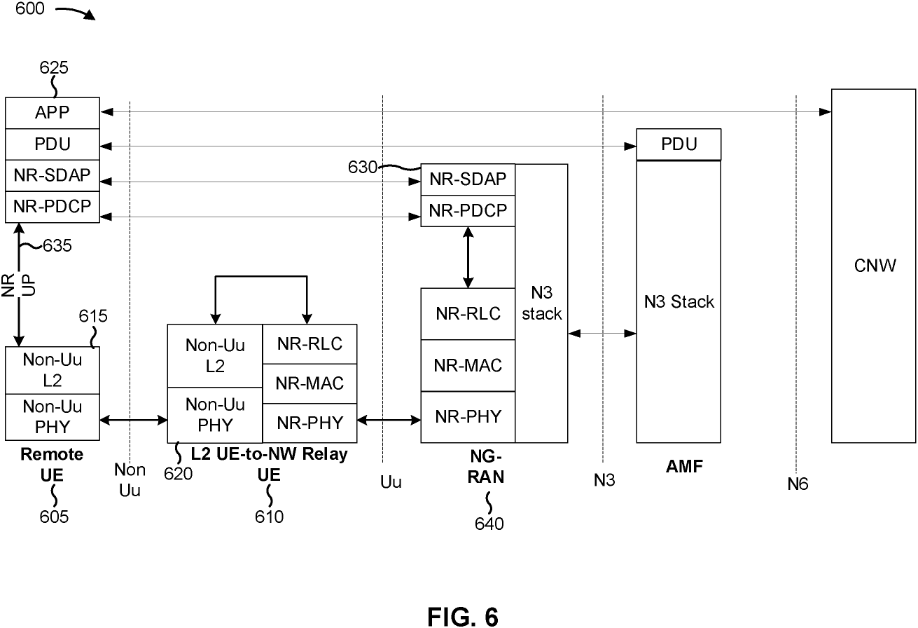

FIG. 5 is a diagram illustrating an example of a control-plane protocol architecture 500 for a layer 2 light UE-to-network relay, in accordance with the present disclosure. FIG. 6 is a diagram illustrating an example of a user-plane protocol architecture 600 for a layer 2 light UE-to-network relay, in accordance with the present disclosure. For example, the control-plane protocol architecture 500 and the user-plane protocol architecture 600 may correspond to a remote UE (e.g., UE 120e) shown by reference numbers 505 and 605 and a relay UE (e.g., UE 120a) shown by reference numbers 510 and 610.

A layer 2 light UE-to-network relay may perform relaying operations at layer 2 of the protocol stack. Unlike the layer 2 UE-to-network relays illustrated and described above in connection with FIGS. 3 and 4, a layer 2 light UE-to-network relay may manage the link between the layer 2 light UE-to-network relay and the remote UE locally (e.g., as opposed to this link being managed by the NG-RAN). The link between the layer 2 light UE-to-network relay and the remote UE may be referred to a non-Uu link in that this link may support PC5 (e.g., sidelink) and/or other types of wireless access technologies such as Bluetooth, Bluetooth low energy (BLE), Wi-Fi direct, Wi-Fi and/or the like.

As shown in FIG. 5, in the control-plane, there may be a non-Uu interface between the remote UE and the relay UE, a Uu interface (e.g., an access link interface) between the relay UE and a 5G-AN, an N2 interface between the NG-RAN and an AMF of the control-plane protocol architecture 500, and an N11 interface between the AMF (e.g., which may be implemented by a network controller 130) and an SMF (e.g., which may be implemented by a network controller 130).

As shown in FIG. 6, there may be an N3 interface between the NG-RAN and a UPF (e.g., which may be implemented by a network controller 130) of the user-plane protocol architecture 600, and an N6 interface between the UPF and a CNW.

As further shown, the remote UE and the relay UE may be associated with respective non-Uu protocol stacks 515/520 and 615/620, enabling communication on the non-Uu interface(s) between the remote UE and the relay UE. The non-Uu protocol stack may include a non-Uu-L2 component (which may include one or more components such as one or more RLC components, one or more MAC components, and/or the like for different types of wireless access technologies), a non-Uu-PHY component, and/or the like. Communications between the remote UE and the relay UE using the non-Uu interface may be referred to as sidelink communication, P2P communication, or another type of communication.

As shown by reference number 530 of FIG. 5, the remote UE is associated with an NAS stack, which includes an NAS-SM component, NAS-MM component, and one or more radio access components (e.g., an NR-RRC component and an NR-PDCP component). As shown by reference number 535 of FIG. 5, the relay UE is associated with a radio access stack, including an NR-RLC component, an NR-MAC component, and an NR-PHY component. Furthermore, the NG-RAN is associated with a radio access interface stack shown by reference number 540, which includes an NR-RLC component, an NR-MAC component, an NR-PHY component, an NR-RRC entity, and an NR-PDCP entity.

In some aspects, the layer 2 light UE-to-network relays of FIGS. 5 and 6 may handle relatively fewer connections with remote UEs relative to the layer 2 UE-to-network relays described above in connection with FIGS. 3 and 4. As a result, the adaption relay component may be omitted from layer 2 light UE-to-network relays of FIGS. 5 and 6, since the layer 2 light UE-to-network relays of FIGS. 5 and 6 may not need to handle multiplexing of traffic for multiple remote UEs. In some cases, the layer 2 light UE-to-network relays of FIGS. 5 and 6 may be associated with a single remote UE and may relay traffic for the particular UE. In some aspects, the adaptation layer may be included in some aspects for layer 2 light UE-to-network relays.

Communication between stacks of the remote UE is indicated by the lines shown by reference number 550. The line between the NR-PDCP entity and the non-Uu-L2 entity indicates how a message (e.g., an NR RRC message generated by the radio access protocol stack) that is not encapsulated in a sidelink signaling container might be communicated from the radio access stack to the non-Uu stack for transmission via the non-Uu interface.

As shown by reference number 625 of FIG. 6, the remote UE is associated with a user-plane protocol stack, which may include an APP component, a PDU component, an NR-SDAP component, and an NR-PDCP component. Furthermore, the NG-RAN is associated with user-plane components shown by reference number 630, which include an NR-SDAP component and an NR-PDCP component. The NR-SDAP component and the NR-PDCP component may be referred to herein as radio access entities.

NR user-plane traffic (shown by a line indicated by “NR UP”) may be transported between the NR-PDCP entity and the non-Uu-L2 component, as shown by reference number 635. Such NR user-plane traffic may be transported to the relay UE via one or more bearers, such as a DRB.

As indicated above, FIGS. 5 and 6 are provided as examples. Other examples may differ from what is described with respect to FIGS. 5 and 6.

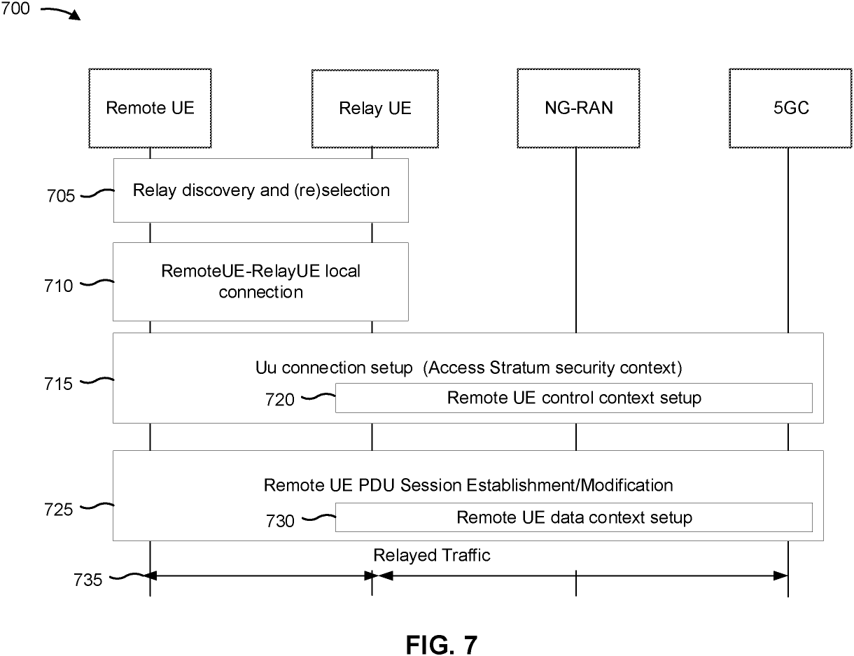

FIG. 7 is a diagram illustrating an example 700 of establishing a layer 2 relay connection for a layer 2 light UE-to-network relay, in accordance with the present disclosure. As shown in FIG. 7, example 700 includes communication between a remote UE (e.g., UE 120e, remote UE 505, remote UE 605, and/or the like), a layer 2 light relay UE (e.g., UE 120a, relay UE 510, relay UE 610, and/or the like), an NG-RAN (e.g., a base station 110), and one or more 5G core network (5GC) components (e.g., an AMF component, an SMF component, a UPF component, a network controller 130, and/or the like.

As shown in FIG. 7, and by reference number 705, the remote UE and the relay UE may perform relay discovery and selection (or reselection) to discover each other. The remote UE and the relay UE may determine that the remote UE has requested a layer 2 light relay service. For example, the relay UE may determine that the remote UE has requested the layer 2 light relay service based at least in part on the announcement message or solicitation message. In some aspects, the relay UE may determine that the remote UE has requested a layer 2 based at least in part on a reserved layer 2 light relay service code associated with layer 2 relays. For example, a layer 2 light relay service code may indicate a type of layer 2 light relay service that the remote UE desires to perform. If the layer 2 light relay service code has a particular value or is within a particular range, the relay UE may determine that the layer 2 light relay service is a layer 2 light relay service. In some aspects, one or more bits (e.g., one or more first bits) of a relay service code may indicate which type of UE-to-NW relay service is supported. For example, a first bit value (e.g., 00) may indicate layer 3 relaying, a second bit value (e.g., 01) may indicate layer 2 light relaying, and a third bit value (e.g., 10) may indicate both layer 2 light and layer 3 relaying. In some aspects, a relay service code may indicate support of layer 3 relaying, layer 2 light relaying, or both via a field or flag value received during policy provisioning of the corresponding UE.

As further shown in FIG. 7, and by reference number 710, the remote UE and the relay UE may establish a remote UE to relay UE local connection. The local connection may include a non-Uu connection, such as a PC5 connection (e.g., a sidelink connection), a Bluetooth connection, a BLE connection, a Wi-Fi direct connection, and/or another type of wireless communication. In some aspects, the remote UE and the relay UE may manage the local connection between the remote UE and the relay UE without assistance from the NG-RAN.

As further shown in FIG. 7, and by reference numbers 715 and 720, the remote UE may establish a Uu (or access link) connection with the NG-RAN and 5GC, which may include setting up a remote UE control context for the remote UE at the Relay UE. In one example, the remote UE control context at the relay UE only includes the setup of the Uu RLC channels corresponding to the remote UE SRBs and not the remote UE to relay link RLC channel context for layer 2 light relays. For example, the remote UE (e.g., through the relay UE) may perform RRC connection/access stratum (AS) security context establishment with the NG-RAN and/or the AMF of the 5GC. Moreover, the remote UE (e.g., through the relay UE) may perform NAS connection/NAS security context establishment with the NG-RAN and/or the AMF of the 5GC.

As further shown in FIG. 7, and by reference numbers 725 and 730, the remote UE may establish and/or modify a remote UE PDU session with the 5G-RAN and the 5GC, which may include setting up a remote UE data context for the remote UE at the Relay UE. In one example, the remote UE data context at the relay UE only includes the setup of the Uu RLC channels corresponding to the remote UE DRBs and not the remote UE to Relay link RLC channel context for layer 2 light relays. Thereafter, and as shown by reference number 735, the remote UE and the relay UE may communicate relayed traffic with the UPF of the 5GC.

As indicated above, FIG. 7 is provided as an example. Other examples may differ from what is described with respect to FIG. 7.

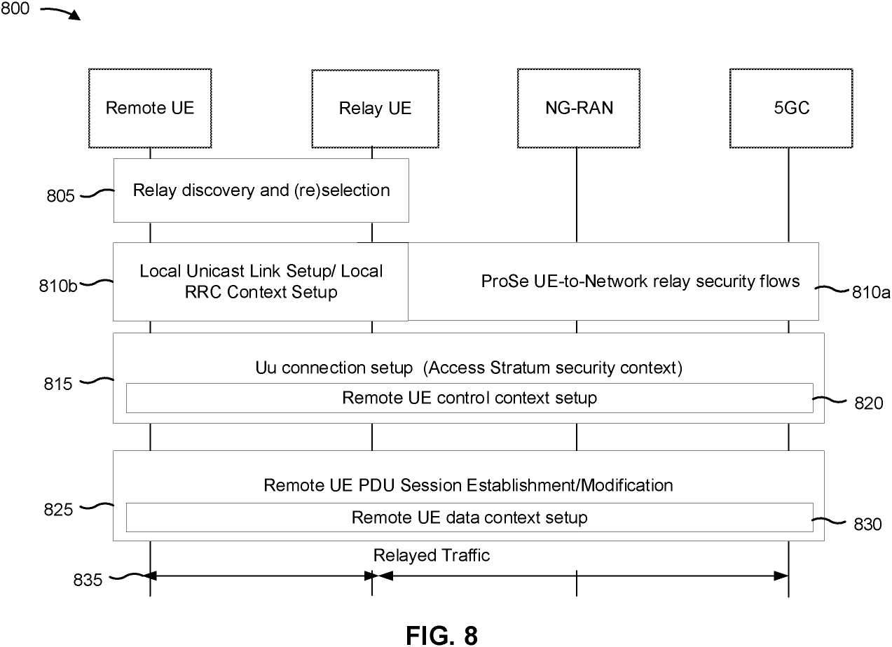

FIG. 8 is a diagram illustrating an example 800 of establishing a layer 2 relay connection for a layer 2 UE-to-network relay, in accordance with the present disclosure. As shown in FIG. 8, example 800 includes communication between a remote UE (e.g., UE 120e, remote UE 305, remote UE 405, and/or the like), a layer 2 relay UE (e.g., UE 120a, relay UE 310, relay UE 410, and/or the like), an NG-RAN (e.g., a base station 110, NG-RAN 340, NG-RAN 440, and/or the like), and one or more 5GC components (e.g., an AMF component, an SMF component, a UPF component, a network controller 130, and/or the like).

As shown in FIG. 8, and by reference number 805, the remote UE and the relay UE may perform relay discovery and selection (or reselection) to discover each other. The remote UE and the relay UE may determine that the remote UE has requested a layer 2 relay service. For example, the relay UE may determine that the remote UE has requested the layer 2 relay service based at least in part on the announcement message or solicitation message. In some aspects, the relay UE may determine that the remote UE has requested a layer 2 based at least in part on a reserved relay service code associated with layer 2 relays. For example, a relay service code may indicate a type of layer 2 relay service that the remote UE desires to perform. If the relay service code has a particular value or is within a particular range, the relay UE may determine that the layer 2 relay service is an layer 2 relay service. In some aspects, one or more bits (e.g., one or more first bits) of a relay service code may indicate which type of UE-to-NW relay service is supported. For example, a first bit value (e.g., 00) may indicate layer 3 relaying, a second bit value (e.g., 01) may indicate layer 2 relaying, and a third bit value (e.g., 10) may indicate both layer 2 and layer 3 relaying. In some aspects, a relay service code may indicate support of layer 3 relaying, layer 2 relaying, or both via a field or flag value received during policy provisioning of the corresponding UE.

As further shown in FIG. 8, and by reference number 810, the remote UE, the relay UE, the NG-RAN, and the 5GC may establish a local connection between the remote UE to relay UE and a Uu (e.g., access link) connection between the relay UE and the NG-RAN. The local connection may include a PC5 (e.g., sidelink) connection, WiFi-D, WiFi, BT, BTLE, and/or another type of local connection. Establishing the local connection for sidelink may include, for example, the relay UE, the NG-RAN, and the 5GC establishing a set of ProSe UE-to-network relay security flows for the remote UE (reference number 810a) and setting up a PC5 unicast link and a PC5-RRC context for the remote UE (reference number 810b).

As further shown in FIG. 8, and by reference numbers 815 and 820, the remote UE may establish a Uu (or access link) connection with the NG-RAN and 5GC, which may include setting up a remote UE control context for the remote UE at the Relay UE. In one example, the remote UE control context includes the Uu RLC channel configuration, adaptation configuration at Relay UE and the Pc5 RLC channel configuration for the Remote UE. For example, the remote UE (e.g., through the relay UE) may perform RRC connection/AS security context establishment with the NG-RAN and/or the AMF of the 5GC. Moreover, the remote UE (e.g., through the relay UE) may perform NAS connection/NAS security context establishment with the NG-RAN and/or the AMF of the 5GC.

As further shown in FIG. 8, and by reference numbers 825 and 830, the remote UE may establish and/or modify a remote UE PDU session with the 5G-RAN and the 5GC, which may include setting up a remote UE data context for the remote UE at the relay UE. In one example, the remote UE data context includes the Uu RLC channel configuration, adaptation configuration at relay UE and the Pc5 RLC channel configuration for the remote UE for the Remote UE DRBs.

In some aspects, unlike a local connection between a layer 2 light UE-to-network relay and a remote UE (which is managed locally between the remote UE and the relay UE), the NG-RAN may control the local connection (e.g., the PC5 unicast link) between the remote UE and the relay UE during establishment of the Uu connection (e.g., at reference number 815 and 820) and/or during the remote PDU session establishment (e.g., at reference numbers 825 and 830). Thereafter, and as shown by reference number 835, the remote UE and the relay UE may communicate relayed traffic with the UPF of the 5GC.

As indicated above, FIG. 8 is provided as an example. Other examples may differ from what is described with respect to FIG. 8.

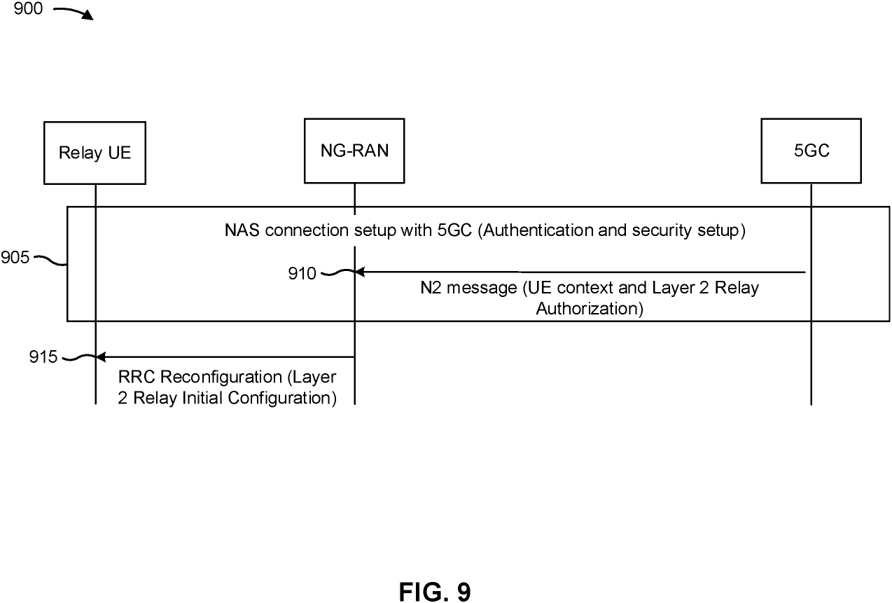

FIG. 9 is a diagram illustrating an example 900 associated with a layer 2 relay initial configuration, in accordance with the present disclosure. In some aspects, example 900 may be performed as part of establishing a layer 2 relay connection for a layer 2 light UE-to-network relay as described above in connection with FIG. 7 and/or as part of establishing a layer 2 relay connection for a layer 2 UE-to-network relay as described above in connection with FIG. 8. As shown in FIG. 9, example 900 may include communication between a relay UE (e.g., UE 120a, relay UE 310, relay UE 410, relay UE 510, relay UE 610, the relay UE described above in connection with FIGS. 7 and/or 8, and/or the like), an NG-RAN (e.g., a base station 110, NG-RAN 340, NG-RAN 440, NG-RAN 540, NG-RAN 640, the NG-RAN described above in connection with FIGS. 7 and/or 8, and/or the like), and one or more 5GC components (e.g., an AMF component, an SMF component, a UPF component, a network controller 130, and/or the like).

As shown in FIG. 9, and by reference number 905, the relay UE, the NG-RAN, and one or more components in the 5GC may perform a network connection setup procedure for the relay UE. The network connection setup procedure includes a procedure to establish and/or set up an NAS connection between the relay UE and the 5GC. The relay UE may initiate the network connection setup procedure with the NG-RAN to establish a new connection with the NG-RAN, to transition out of an RRC idle mode, to transition out of an RRC inactive mode, and/or the like. In some aspects, the relay UE may be in the coverage area of the NG-RAN and may initiate the network connection setup procedure with a network entity (e.g., the NG-RAN an AMF, and/or the like) as part of the NAS connection setup with the 5GC. The network connection setup procedure may include a registration procedure, which may include a NAS connection setup procedure in which the relay UE, the NG-RAN, and/or the 5GC components perform authentication and security set up as part of a NAS registration procedure. In some aspects, the NAS connection setup procedure may include the relay UE, the NG-RAN, and/or the 5GC components performing an AS security setup during an RRC connection setup procedure. In some aspects, the registration procedure may be performed according to 3GPP TS 23.502. In some aspects, the network connection setup procedure may include a service request procedure, in which the relay UE, the NG-RAN, and/or the 5GC components perform authentication and security set up as part of the relay UE transitioning out of an idle mode to activate and obtain service on a connection between the relay UE and the NG-RAN. In some aspects, the service request procedure may be performed according to 3GPP TS 23.502.

As further shown in FIG. 9, and by reference number 910, once authentication with the NG-RAN and the 5GC is successful, an AMF of the 5GC may provide a UE context to the NG-RAN. The UE context may be associated with the relay UE. The AMF may provide the UE context to the NG-RAN via a core network interface such as an N2 interface. Moreover, the AMF may provide an indication to the NG-RAN that the relay UE has a capability to operate as a layer 2 relay UE (e.g., a capability to operate as layer 2 UE-to-network relay UE in which the relay UE forwards or relays layer 2 traffic between a wireless network and a remote UE). The indication that the UE has a capability to operate as a layer 2 relay UE may include, for example, an indication of a layer 2 relay authorization (e.g., that the relay UE is authorized to operate as a layer 2 relay and is authorized to forward or relay layer 2 traffic between a wireless network and a remote UE), as indicated in FIG. 9. The AMF may provide the indication in an N2 message (which is a type of message that is transmitted via the N2 interface) or another core network interface.

As further shown in FIG. 9, and by reference number 915, the NG-RAN may provide a layer 2 relay initial configuration to the relay UE. In some aspects, the NG-RAN may provide the layer 2 relay initial configuration to the relay UE based at least in part on receiving the indication from the AMF that the relay UE has a capability to operate as a layer 2 relay UE. In some aspects, the NG-RAN may transmit the layer 2 relay initial configuration to the relay UE in an RRC message, such as an RRC reconfiguration message, an RRC resume message, or another type of RRC message.

The layer 2 relay initial configuration may include one or more configurations that assist the relay UE (and/or a remote UE that connects to the relay UE for a layer 2 relay service, for a layer 2 light relay service, and/or the like) to send and receive initial RRC messages to and from the NG-RAN. The one or more configurations may be configured for one or more SRB types, such as an SRB 0 (SRB0) or another type of SRB. The one or more configurations may include an RLC configuration (e.g., an access link or Uu RLC channel configuration for relaying access link SRB traffic for remote UEs), an adaptation configuration (e.g., a type of configuration for an adaptation layer entity of the relay UE for an SRB for mapping between an access link or Uu RLC channel and a non-Uu RLC channel (e.g., a PC5 or sidelink RLC channel, WiFi, WiFi-D, BT, BTLE, etc)), a sidelink or PC5 RLC channel configuration for relaying traffic for remote UEs on a sidelink SRB, and/or the like. In some aspects, the RLC channel configuration may include an RLC entity configuration, a MAC logical channel configuration, a PHY layer configuration and/or the like.

As indicated above, FIG. 9 is provided as an example. Other examples may differ from what is described with respect to FIG. 9.

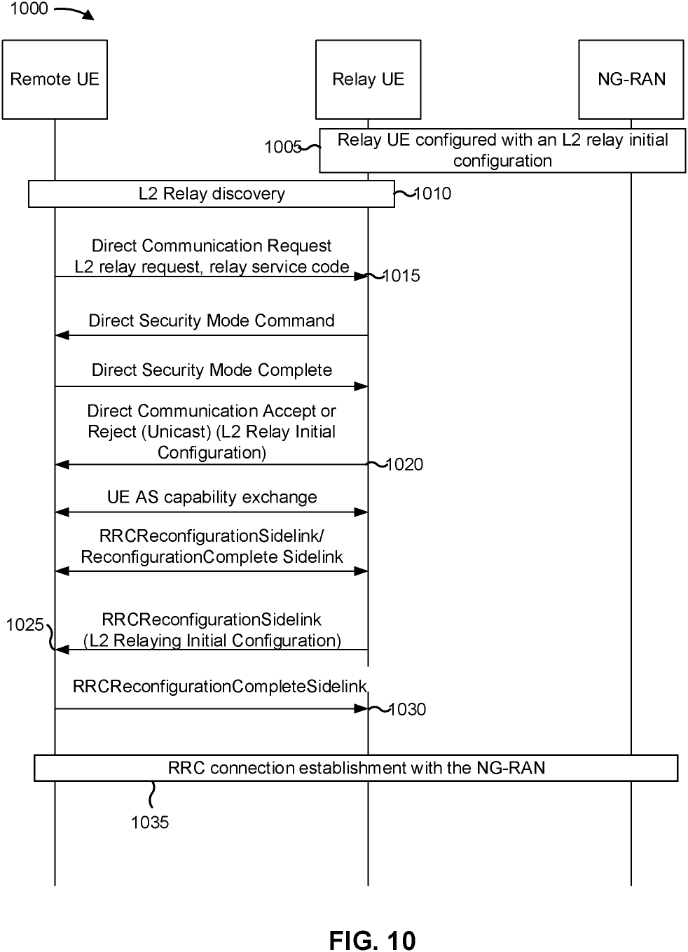

FIG. 10 is a diagram illustrating an example 1000 associated with a layer 2 relay initial configuration, in accordance with the present disclosure. In some aspects, example 1000 may be performed as part of establishing a layer 2 relay connection for a layer 2 light UE-to-network relay as described above in connection with FIG. 7 and/or as part of establishing a layer 2 relay connection for a layer 2 UE-to-network relay as described above in connection with FIG. 8. As shown in FIG. 10, example 1000 may include communication between a remote UE (e.g., UE 120e, remote UE 305, remote UE 405, remote UE 505, remote UE 605, the remote UE described above in connection with FIGS. 7 and/or 8, and/or the like), a relay UE (e.g., UE 120a, relay UE 310, relay UE 410, relay UE 510, relay UE 610, the relay UE described above in connection with FIGS. 7 and/or 8, and/or the like), and an NG-RAN (e.g., a base station 110, NG-RAN 340, NG-RAN 440, NG-RAN 540, NG-RAN 640, the NG-RAN described above in connection with FIGS. 7 and/or 8, and/or the like).

As shown in FIG. 10, and by reference number 1005, the relay UE may be configured with a layer 2 relay initial configuration. For example, the NG-RAN (in combination with a 5GC) may provide the layer 2 relay configuration in a similar manner as described above in connection with FIG. 9.

As further shown in FIG. 10, and by reference number 1010, the remote UE and the relay UE may perform layer 2 relay discovery. For example, the remote UE and the relay UE may perform one or more of the operations described with regard to FIGS. 5, 6, and 7. Thus, the remote UE may identify the relay UE as a potential relay UE for a layer 2relay service, a layer 2 light relay service, and/or the like. In some aspects, the remote UE may perform layer 2 relay discovery based at least in part on an application associated with a particular service initiating. For example, the remote UE may determine that the layer 2 relay service or the layer 2 light relay service is to be requested based at least in part on the application initiating and may accordingly perform layer 2 relay discovery in order to identify a relay UE capable of providing a layer 2 relay service or a layer 2 light relay service.

As further shown in FIG. 10, and by reference number 1015, the remote UE may provide a direct communication request to the relay UE. In some aspects, the direct communication request may include a layer 2 relay request, which may also be referred to as a request to establish a layer 2 relay service. In some aspects, the direct communication request may include a layer 2 light relay request, which may also be referred to as a request to establish a layer 2 light relay service. In some aspects, the direct communication request may include a relay service code. The relay service code may identify a relay type of the layer 2 relay service or the layer 2 light relay service. For example, the relay service code may identify the layer 2 relay service or the layer 2 light relay service as an emergency service, a gaming service, a low-latency service, or another type of service. In some aspects, the layer 2 relay request (or layer 2 light relay request) and/or the relay service code may be provided in another message, such as the direct security mode complete message shown in FIG. 10.

As shown by reference number 1020, the relay UE may provide, to the remote UE, information indicating whether the relay UE accepts or rejects the layer 2 relay service or the layer 2 light relay service. For example, the relay UE may determine whether to accept or reject the layer 2 relay service or the layer 2 light relay service based at least in part on the relay service code associated with the layer 2 relay service or the layer 2 light relay service. The relay UE may provide the information indicating whether the relay UE accepts or rejects the layer 2 relay service or the layer 2 light relay service in a direct communication accept message (indicating that the relay UE accepts the layer 2 relay service or the layer 2 light relay service) or a direct communication reject message (indicating that the relay UE rejects the layer 2 relay service or the layer 2 light relay service). In some aspects, the direct communication reject message may indicate that the relay UE rejects the layer 2 relay service or the layer 2 light relay service based at least in part on a cause value. For example, the cause value may indicate that the specified layer 2 relay service or the layer 2 light relay service cannot be supported or is not supported. In some aspects, the relay UE May provide the information indicating whether the relay UE accepts or rejects the layer 2 relay service or the layer 2 light relay service after a direct security mode command message and/or a direct security mode complete message are exchanged between the relay UE and the remote UE (e.g., after establishment of security for the unicast link is complete).

As further shown in FIG. 10, the PC5-S direct communication accept message sent to indicate the successful setup of PC5 unicast link may include at least a portion of the layer 2 relay initial configuration. For non-Uu link setup, the portion of layer 2 relay initial configuration may be sent in the non-Uu specific link accept message. The portion of the layer 2 relay initial configuration provided by the relay UE to the remote UE may include a sidelink (or another type of non-Uu link) RLC channel configuration for relaying SRB traffic between the remote UE and the NG-RAN. The sidelink RLC channel configuration for relaying SRB traffic (e.g., SRBO traffic) may be different from the access link RLC channel configuration for the SRB traffic between the relay UE and the NG-RAN. RLC access management may also be used. In some aspects, the relay UE may transmit at least a portion of the layer 2 relay initial configuration to the remote UE based at least in part on receiving the direct communication request from the remote UE.

Additionally, and/or alternatively, and as shown by reference number 1025, the relay UE may transmit at least a portion of the layer 2 relay initial configuration in an RRC reconfiguration message, such as an RRC reconfiguration sidelink message (e.g., a PC5-RRC message). In these examples, the relay UE may reconfigure the remote UE with the layer 2 relay initial configuration. Thus, the relay UE may configure the PC5 unicast link (or another type of non-Uu unicast link) with one or more SRBs to be used by the remote UE for the layer 2 relay service. As shown by reference number 1030, the remote UE may transmit an RRC reconfiguration complete sidelink message to the relay UE to indicate that the RRC reconfiguration was completed successfully.

As further shown in FIG. 10, and by reference number 1035, the remote UE may initiate an RRC connection establishment with the NG-RAN via the relay UE based at least in part on the layer 2 relay initial configuration. For example, the remote UE may transmit an SRB (e.g., an SRBO) RRC setup request to the relay UE based at least in part on the sidelink RLC channel configuration included in the layer 2 relay initial configuration.

The relay UE may receive the SRB RRC setup request from the remote UE and may relay the SRB RRC setup request to the NG-RAN and/or one or more 5GC components based at least in part on the layer 2 relay initial configuration. For example, the relay UE may receive the SRB RRC setup request on the non-Uu link between the relay UE and the remote UE based at least in part on the sidelink or PC5 RLC channel configuration in the layer 2 relay initial configuration. As another example, the relay UE may perform multiplexing of the SRB RRC setup request with SRB traffic of multiple UEs on the access link or Uu link between the relay UE and the NG-RAN based at least in part on the adaptation configuration in the layer 2 initial relay configuration for SRB mapping between the access link or Uu RLC channel of the access link and the non-Uu RLC channel of the non-Uu link between the relay UE and the remote UE. As another example, the relay UE may transmit the SRB RRC setup request to the NG-RAN based at least in part on the access link or Uu RLC channel configuration in the layer to initial relay configuration.

As another example, the relay UE may receive an RRC setup message from the NG-RAN and/or one or more 5GC components and may relay the RRC setup message to the remote UE based at least in part on the layer 2 relay initial configuration. For example, the relay UE may receive the RRC setup message from the NG-RAN based at least in part on the access link or Uu RLC channel configuration in the layer to initial relay configuration. As another example, the relay UE may transmit the RRC setup message to the remote UE on the non-Uu link between the relay UE and the remote UE based at least in part on the sidelink or PC5 RLC channel configuration in the layer 2 relay initial configuration.

As indicated above, FIG. 10 is provided as an example. Other examples may differ from what is described with regard to FIG. 10.

FIG. 11 is a diagram illustrating an example process 1100 performed, for example, by a relay UE, in accordance with the present disclosure. Example process 1100 is an example where the relay UE (e.g., UE 120a, relay UE 310, relay UE 410, relay UE 510, relay UE 610, the relay UE illustrated and described above in connection with FIGS. 7-10) performs operations associated with a layer 2 relay initial configuration.

As shown in FIG. 11, in some aspects, process 1100 may include initiating a connection with a network entity (block 1110). For example, the relay UE (e.g., using antenna 252, demodulator 254, MIMO detector 256, receive processor 258, transmit processor 264, TX MIMO processor 266, modulator 254, controller/processor 280, memory 282, initiation component 1510, and/or the like) may initiate a connection with a network entity, as described above.

As further shown in FIG. 11, in some aspects, process 1100 may include receiving a layer 2 relay initial configuration based at least in part on initiating the connection (block 1120). For example, the UE (e.g., using antenna 252, demodulator 254, MIMO detector 256, receive processor 258, controller/processor 280, memory 282, reception component 1502, and/or the like) may receive a layer 2 relay initial configuration based at least in part on initiating the connection, as described above.

Process 1100 may include additional aspects, such as any single aspect or any combination of aspects described below and/or in connection with one or more other processes described elsewhere herein.

In a first aspect, initiating the connection with the network entity comprises at least one of performing a successful authentication and security set up with the network entity during an NAS registration and service request procedure, or performing a successful AS security setup with the network entity during RRC connection setup procedure. In a second aspect, alone or in combination with the first aspect, receiving the layer 2 relay initial configuration comprises receiving the layer 2 relay initial configuration in a RRC reconfiguration message from the network entity. In a third aspect, alone or in combination with one or more of the first and second aspects, the layer 2 relay initial configuration includes at least one of, an access link RLC channel configuration for remote UE access link SRB traffic relaying, an adaptation configuration for an SRB for access link RLC channel and sidelink RLC channel mapping, or a sidelink RLC channel configuration for remote UE sidelink SRB traffic relaying. In a fourth aspect, alone or in combination with one or more of the first through third aspects, the RLC channel configuration includes at least one of an RLC entity configuration a MAC logical channel configuration, or a PHY layer configuration.

In a fifth aspect, alone or in combination with one or more of the first through fourth aspects, process 1100 includes receiving a request to establish a layer 2 relay service from a remote UE and transmitting the layer 2 relay initial configuration to the remote UE based at least in part on receiving the request. In a sixth aspect, alone or in combination with one or more of the first through fifth aspects, transmitting the layer 2 relay initial configuration to the remote UE includes transmitting the layer 2 relay initial configuration to the remote UE in a PC5-S message indicating that set up of a PC5 unicast link between the remote UE and the relay UE was successful.

In a seventh aspect, alone or in combination with one or more of the first through sixth aspects, transmitting the layer 2 relay initial configuration to the remote UE includes transmitting the layer 2 relay initial configuration to the remote UE in a PC5-RRC message. In an eighth aspect, alone or in combination with one or more of the first through seventh aspects, the layer 2 relay initial configuration includes a sidelink RLC channel configuration for relaying SRBO traffic between the remote UE and a base station.

In a ninth aspect, alone or in combination with one or more of the first through eighth aspects, process 1100 includes receiving an SRBO RRC setup request from the remote UE and relaying the SRBO RRC setup request to a network entity based at least in part on the layer 2 relay initial configuration. In a tenth aspect, alone or in combination with one or more of the first through ninth aspects, process 1100 includes receiving an RRC setup message from the network entity and relaying the RRC setup message to the remote UE based at least in part on the layer 2 relay initial configuration.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network entity, in accordance with the present disclosure. Example process 1200 is an example where the network entity (e.g., base station 110, NG-RAN 340, NG-RAN 440, NG-RAN 540, NG-RAN 640, the NG-RAN illustrated and described above in connection with FIGS. 7-10, and/or the like) performs operations associated with a layer 2 relay initial configuration.

As shown in FIG. 12, in some aspects, process 1200 may include receiving an indication that a UE has a capability to operate as a layer 2 relay UE (block 1210). For example, the network entity (e.g., using antenna 234, demodulator 232, MIMO detector 236, receive processor 238, controller/processor 240, memory 242, scheduler 246, reception component 1802, and/or the like) may receive an indication that a UE has a capability to operate as a layer 2 relay UE, as described above.

As further shown in FIG. 12, in some aspects, process 1200 may include transmitting a layer 2 relay initial configuration to the UE based at least in part on receiving the indication (block 1220). For example, the network entity (e.g., using transmit processor 220, TX MIMO processor 230, modulator 232, antenna 234, controller/processor 240, memory 242, scheduler 246, transmission component 1806, and/or the like) may transmit a layer 2 relay initial configuration to the UE based at least in part on receiving the indication, as described above.

Process 1200 may include additional aspects, such as any single aspect or any combination of aspects described below and/or in connection with one or more other processes described elsewhere herein.

In a first aspect, receiving the indication comprises receiving the indication from another network entity based on successful UE authentication and security setup. In a second aspect, alone or in combination with the first aspect, receiving the indication comprises receiving the indication in an N2 message during a NAS registration and service request procedure. In a third aspect, alone or in combination with one or more of the first and second aspects, transmitting the layer 2 relay initial configuration comprises transmitting the layer 2 relay initial configuration in a RRC reconfiguration message.

In a fourth aspect, alone or in combination with one or more of the first through third aspects, the layer 2 relay initial configuration includes at least one of, an access link RLC channel configuration for remote UE access link SRB traffic relaying, an adaptation configuration for an SRB for access link RLC channel and sidelink RLC channel mapping, or a sidelink RLC channel configuration for remote UE sidelink SRB traffic relaying. In a fifth aspect, alone or in combination with one or more of the first through fourth aspects, the RLC channel configuration includes at least one of an RLC entity configuration a MAC logical channel configuration, or a PHY layer configuration.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a relay UE, in accordance with the present disclosure. Example process 1300 is an example where the relay UE (e.g., UE 120a, relay UE 310, relay UE 410, relay UE 510, relay UE 610, the relay UE illustrated and described above in connection with FIGS. 7-10) performs operations associated with a layer 2 relay initial configuration.

As shown in FIG. 13, in some aspects, process 1300 may include receiving a request to establish a layer 2 relay service from a remote UE (block 1310). For example, the relay UE (e.g., using antenna 252, demodulator 254, MIMO detector 256, receive processor 258, controller/processor 280, memory 282, reception component 1502, and/or the like) may receive a request to establish a layer 2 relay service from a remote UE, as described above.

As further shown in FIG. 13, in some aspects, process 1300 may include transmitting a layer 2 relay initial configuration to the remote UE based at least in part on receiving the request (block 1320). For example, the relay UE (e.g., using antenna 252, transmit processor 264, TX MIMO processor 266, modulator 254, controller/processor 280, memory 282, transmission component 1506, and/or the like) may transmit a layer 2 relay initial configuration to the remote UE based at least in part on receiving the request, as described above.

Process 1300 may include additional aspects, such as any single aspect or any combination of aspects described below and/or in connection with one or more other processes described elsewhere herein.

In a first aspect, transmitting the layer 2 relay initial configuration to the remote UE comprises transmitting the layer 2 relay initial configuration to the remote UE in a PC5-S message indicating that set up of a PC5 unicast link between the remote UE and the relay UE was successful. In a second aspect, alone or in combination with the first aspect, transmitting the layer 2 relay initial configuration to the remote UE comprises transmitting the layer 2 relay initial configuration to the remote UE in a PC5-RRC message. In a third aspect, alone or in combination with one or more of the first and second aspects, the layer 2 relay initial configuration includes a sidelink RLC channel configuration for relaying SRB traffic between the remote UE and a base station.

In a fourth aspect, alone or in combination with one or more of the first through third aspects, process 1300 includes receiving an SRBO RRC setup request from the remote UE and relaying the SRBO RRC setup request to a network entity based at least in part on the layer 2 relay initial configuration. In a fifth aspect, alone or in combination with one or more of the first through fourth aspects, process 1300 includes receiving an RRC setup message from the network entity and relaying the RRC setup message to the remote UE based at least in part on the layer 2 relay initial configuration.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a remote UE, in accordance with the present disclosure. Example process 1400 is an example where the remote UE (e.g., UE 120e, remote UE 305, remote UE 405, remote UE 505, remote UE 605, the remote UE illustrated and described above in connection with FIGS. 7-10, and/or the like) performs operations associated with a layer 2 relay initial configuration.

As shown in FIG. 14, in some aspects, process 1400 may include transmitting a request to establish a layer 2 relay service to a relay UE (block 1410). For example, the remote UE (e.g., using antenna 252, transmit processor 264, TX MIMO processor 266, modulator 254, controller/processor 280, memory 282, transmission component 2106, and/or the like) may transmit a request to establish a layer 2 relay service to a relay UE, as described above.

As further shown in FIG. 14, in some aspects, process 1400 may include receiving a layer 2 relay initial configuration from the relay UE based at least in part on transmitting the request (block 1420). For example, the remote UE (e.g., using antenna 252, demodulator 254, MIMO detector 256, receive processor 258, controller/processor 280, memory 282, reception component 2102, and/or the like) may receive a layer 2 relay initial configuration from the relay UE based at least in part on transmitting the request, as described above.

Process 1400 may include additional aspects, such as any single aspect or any combination of aspects described below and/or in connection with one or more other processes described elsewhere herein.

In a first aspect, receiving the layer 2 relay initial configuration from the relay UE comprises receiving the layer 2 relay initial configuration from the relay UE in a PC5-S message indicating that set up of a PC5 unicast link between the remote UE and the relay UE was successful. In a second aspect, alone or in combination with the first aspect, receiving the layer 2 relay initial configuration from the relay UE comprises receiving the layer 2 relay initial configuration from the relay UE in a PC5-RRC message. In a third aspect, alone or in combination with one or more of the first and second aspects, the layer 2 relay initial configuration includes a sidelink RLC channel configuration for relaying SRB traffic between the remote UE and a network entity. In a fourth aspect, alone or in combination with one or more of the first through third aspects, process 1400 includes initiating an RRC connection with a base station via the relay UE based at least in part on the layer 2 relay initial configuration.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

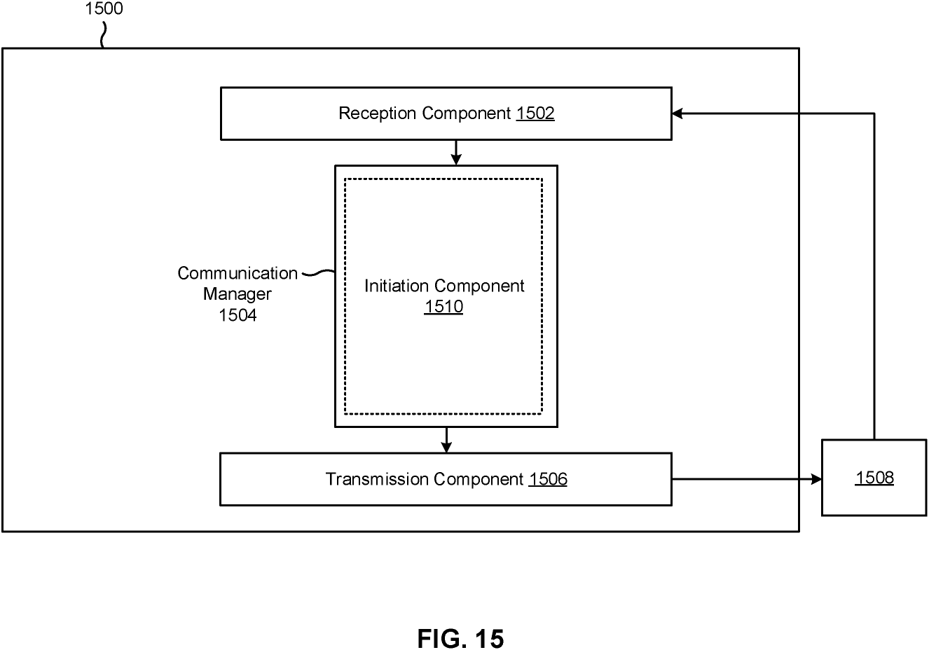

FIG. 15 is a block diagram of an example apparatus 1500 for wireless communication, in accordance with the present disclosure. The apparatus 1500 may be a relay UE, or a relay UE may include the apparatus 1500. In some aspects, the apparatus 1500 includes a reception component 1502, a communication manager 1504, and a transmission component 1506, which may be in communication with one another (for example, via one or more buses). As shown, the apparatus 1500 may communicate with another apparatus 1508 (such as a UE, a base station, or another wireless communication device) using the reception component 1502 and the transmission component 1506.

In some aspects, the apparatus 1500 may be configured to perform one or more operations described herein in connection with FIGS. 7-10. Additionally, or alternatively, the apparatus 1500 may be configured to perform one or more processes described herein, such as process 1100 of FIG. 11, process 1300 of FIG. 13, or a combination thereof. In some aspects, the apparatus 1500 may include one or more components of the relay UE described above in connection with FIG. 2.

The reception component 1502 may receive communications, such as reference signals, control information, data communications, or a combination thereof, from the apparatus 1508. The reception component 1502 may provide received communications to one or more other components of the apparatus 1500, such as the communication manager 1504. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1502 may include one or more antennas, a demodulator, a MIMO detector, a receive processor, a controller/processor, a memory, or a combination thereof, of the relay UE described above in connection with FIG. 2.

The transmission component 1506 may transmit communications, such as reference signals, control information, data communications, or a combination thereof, to the apparatus 1508. In some aspects, the communication manager 1504 may generate communications and may transmit the generated communications to the transmission component 1506 for transmission to the apparatus 1508. In some aspects, the transmission component 1506 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1506 may include one or more antennas, a modulator, a transmit MIMO processor, a transmit processor, a controller/processor, a memory, or a combination thereof, of the relay UE described above in connection with FIG. 2. In some aspects, the transmission component 1506 may be co-located with the reception component 1502 in a transceiver.

In some aspects, the communication manager 1504 may initiate a connection with the apparatus 1508. In some aspects, the communication manager 1504 may receive (or may cause the reception component 1502 to receive) a layer 2 relay initial configuration from the apparatus 1508 based at least in part on initiating the connection. In some aspects, the communication manager 1504 may receive (or may cause the reception component 1502 to receive) a request to establish a layer 2 relay service from the apparatus 1508. In some aspects, the communication manager 1504 may transmit (or may cause the transmission component 1506 to transmit) a layer 2 relay initial configuration to the apparatus 1508 based at least in part on receiving the request. In some aspects, the communication manager 1504 may include a controller/processor, a memory, or a combination thereof, of the relay UE described above in connection with FIG. 2

In some aspects, the communication manager 1504 may include a set of components, such as an initiation component 1510. Alternatively, the set of components may be separate and distinct from the communication manager 1504. In some aspects, one or more components of the set of components may include or may be implemented within a controller/processor, a memory, or a combination thereof, of the relay UE described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component. The initiation component 1510 may initiate a connection with the apparatus 1508.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

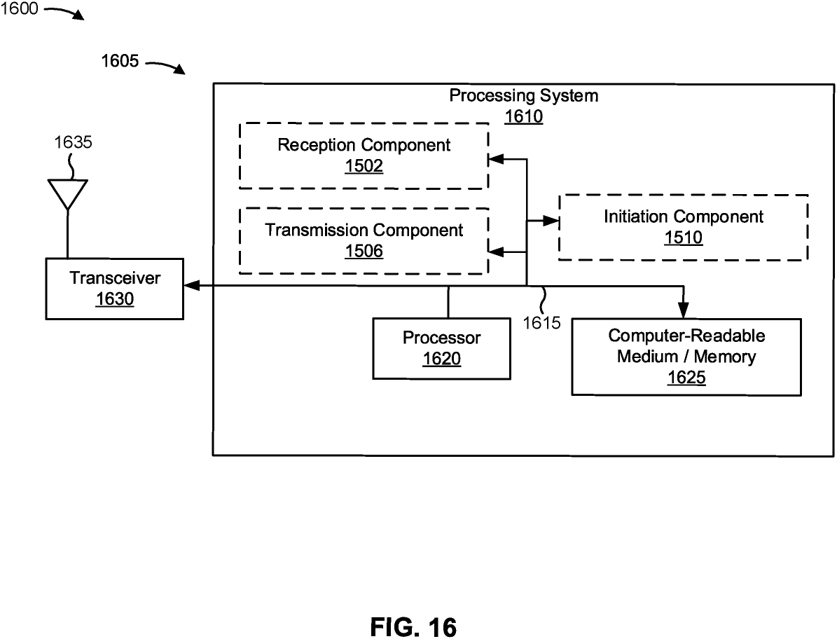

FIG. 16 is a diagram illustrating an example 1600 of a hardware implementation for an apparatus 1605 employing a processing system 1610, in accordance with the present disclosure. The apparatus 1605 may be a relay UE.

The processing system 1610 may be implemented with a bus architecture, represented generally by the bus 1615. The bus 1615 may include any number of interconnecting buses and bridges depending on the specific application of the processing system 1610 and the overall design constraints. The bus 1615 links together various circuits including one or more processors and/or hardware components, represented by the processor 1620, the illustrated components, and the computer-readable medium / memory 1625. The bus 1615 may also link various other circuits, such as timing sources, peripherals, voltage regulators, power management circuits, and/or the like.

The processing system 1610 may be coupled to a transceiver 1630. The transceiver 1630 is coupled to one or more antennas 1635. The transceiver 1630 provides a means for communicating with various other apparatuses over a transmission medium. The transceiver 1630 receives a signal from the one or more antennas 1635, extracts information from the received signal, and provides the extracted information to the processing system 1610, specifically the reception component 1502. In addition, the transceiver 1630 receives information from the processing system 1610, specifically the transmission component 1506, and generates a signal to be applied to the one or more antennas 1635 based at least in part on the received information.

The processing system 1610 includes a processor 1620 coupled to a computer-readable medium / memory 1625. The processor 1620 is responsible for general processing, including the execution of software stored on the computer-readable medium / memory 1625. The software, when executed by the processor 1620, causes the processing system 1610 to perform the various functions described herein for any particular apparatus. The computer-readable medium / memory 1625 may also be used for storing data that is manipulated by the processor 1620 when executing software. The processing system further includes at least one of the illustrated components. The components may be software modules running in the processor 1620, resident/stored in the computer-readable medium / memory 1625, one or more hardware modules coupled to the processor 1620, or some combination thereof.

In some aspects, the processing system 1610 may be a component of the relay UE 120a and may include the memory 282 and/or at least one of the TX MIMO processor 266, the receive (RX) processor 258, and/or the controller/processor 280. In some aspects, the apparatus 1605 for wireless communication includes means for initiating a connection with a network entity, means for receiving a layer 2 relay initial configuration based at least in part on initiating the connection, and/or the like. In some aspects, the apparatus 1605 for wireless communication may include means for receiving a request to establish a layer 2 relay service from a remote UE, means for transmitting a layer 2 relay initial configuration to the remote UE based at least in part on receiving the request, and/or the like. The aforementioned means may be one or more of the aforementioned components of the apparatus 1500 and/or the processing system 1610 of the apparatus 1605 configured to perform the functions recited by the aforementioned means. As described elsewhere herein, the processing system 1610 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 16 is provided as an example. Other examples may differ from what is described in connection with FIG. 16.

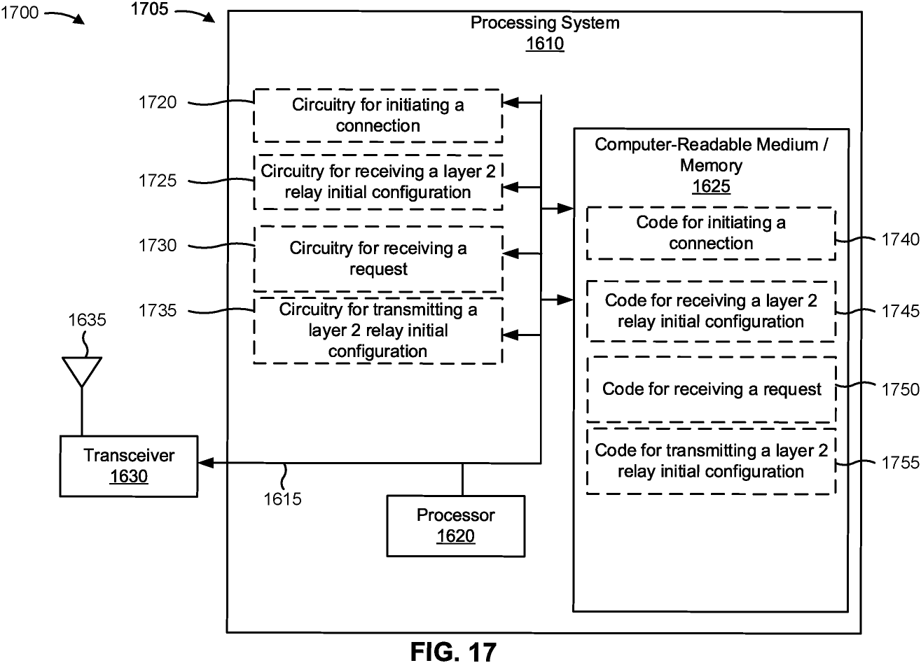

FIG. 17 is a diagram illustrating an example 1700 of an implementation of code and circuitry for an apparatus 1705, in accordance with the present disclosure. The apparatus 1705 may be a relay UE.

As shown in FIG. 17, the apparatus 1705 may include circuitry for initiating a connection (circuitry 1720). For example, the circuitry 1720 may provide means for initiating a connection with a network entity.

As shown in FIG. 17, the apparatus 1705 may include circuitry for receiving a layer 2 relay initial configuration (circuitry 1725). For example, the circuitry 1725 may provide means for receiving a layer 2 relay initial configuration based at least in part on initiating the connection.

As shown in FIG. 17, the apparatus 1705 may include circuitry for receiving a request (circuitry 1730). For example, the circuitry 1730 may provide means for receiving a request to establish a layer 2 relay service from a remote UE.

As shown in FIG. 17, the apparatus 1705 may include circuitry for transmitting a layer 2 relay initial configuration (circuitry 1735). For example, the circuitry 1735 may provide means for transmitting a layer 2 relay initial configuration to the remote UE based at least in part on receiving the request.

The circuitry 1720, 1725, 1730, and/or 1735 may include one or more components of the relay UE 120a described above in connection with FIG. 2, such as communication manager 140, transmit processor 264, TX MIMO processor 266, MOD 254, DEMOD 254, MIMO detector 256, receive processor 258, antenna 252, controller/processor 280, and/or memory 282.

As shown in FIG. 17, the apparatus 1705 may include, stored in computer-readable medium 1625, code for initiating a connection (code 1740). For example, the code 1740, when executed by the processor 1620, may cause the apparatus 1705 to initiate a connection with a network entity.

As shown in FIG. 17, the apparatus 1705 may include, stored in computer-readable medium 1625, code for receiving a layer 2 relay initial configuration (code 1745). For example, the code 1745, when executed by the processor 1620, may cause the apparatus 1705 to receive a layer 2 relay initial configuration based at least in part on initiating the connection.

As shown in FIG. 17, the apparatus 1705 may include, stored in computer-readable medium 1625, code for receiving a request (code 1750). For example, the code 1750, when executed by the processor 1620, may cause the apparatus 1705 to receive a request to establish a layer 2 relay service from a remote UE.

As shown in FIG. 17, the apparatus 1705 may include, stored in computer-readable medium 1625, code for transmitting a layer 2 relay initial configuration (code 1755). For example, the code 1755, when executed by the processor 1620, may cause the apparatus 1705 to transmit a layer 2 relay initial configuration to the remote UE based at least in part on receiving the request.

FIG. 17 is provided as an example. Other examples may differ from what is described in connection with FIG. 17.

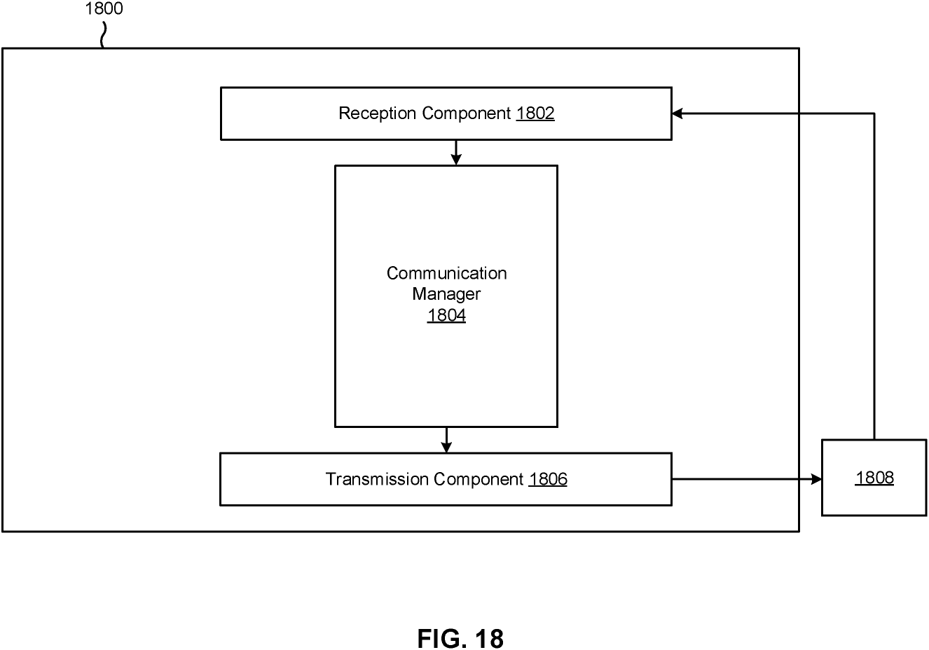

FIG. 18 is a block diagram of an example apparatus 1800 for wireless communication, in accordance with the present disclosure. The apparatus 1800 may be a base station, or a base station may include the apparatus 1800. In some aspects, the apparatus 1800 includes a reception component 1802, a communication manager 1804, and a transmission component 1806, which may be in communication with one another (for example, via one or more buses). As shown, the apparatus 1800 may communicate with another apparatus 1808 (such as a UE, a base station, or another wireless communication device) using the reception component 1802 and the transmission component 1806.

In some aspects, the apparatus 1800 may be configured to perform one or more operations described herein in connection with FIGS. 7-10. Additionally, or alternatively, the apparatus 1800 may be configured to perform one or more processes described herein, such as process 1200 of FIG. 12. In some aspects, the apparatus 1800 may include one or more components of the base station described above in connection with FIG. 2.

The reception component 1802 may receive communications, such as reference signals, control information, data communications, or a combination thereof, from the apparatus 1808. The reception component 1802 may provide received communications to one or more other components of the apparatus 1800, such as the communication manager 1804. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1802 may include one or more antennas, a demodulator, a MIMO detector, a receive processor, a controller/processor, a memory, or a combination thereof, of the base station described above in connection with FIG. 2.

The transmission component 1806 may transmit communications, such as reference signals, control information, data communications, or a combination thereof, to the apparatus 1808. In some aspects, the communication manager 1804 may generate communications and may transmit the generated communications to the transmission component 1806 for transmission to the apparatus 1808. In some aspects, the transmission component 1806 may perform signal processing on the generated communications (such as filtering, amplification, modulation, digital-to-analog conversion, multiplexing, interleaving, mapping, or encoding, among other examples), and may transmit the processed signals to the apparatus 1808. In some aspects, the transmission component 1806 may include one or more antennas, a modulator, a transmit MIMO processor, a transmit processor, a controller/processor, a memory, or a combination thereof, of the base station described above in connection with FIG. 2. In some aspects, the transmission component 1806 may be co-located with the reception component 1802 in a transceiver.

The communication manager 1804 may receive (or may cause the reception component 1802 to receive) an indication that the apparatus 1808 has a capability to operate as a layer 2 relay UE. The communication manager 1804 may transmit (or may cause the transmission component 1806 to transmit) a layer 2 relay initial configuration to the apparatus 1808 based at least in part on receiving the indication. In some aspects, the communication manager 1804 may include a controller/processor, a memory, a scheduler, a communication unit, or a combination thereof, of the base station described above in connection with FIG. 2.

In some aspects, the communication manager 1804 may include a set of components. Alternatively, the set of components may be separate and distinct from the communication manager 1804. In some aspects, one or more components of the set of components may include or may be implemented within a controller/processor, a memory, a scheduler, a communication unit, or a combination thereof, of the base station described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

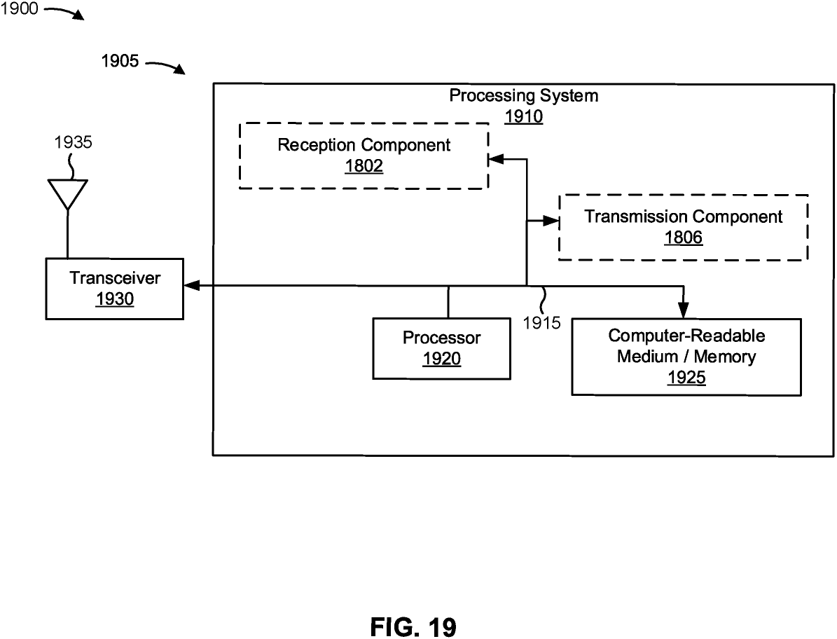

FIG. 19 is a diagram illustrating an example 1900 of a hardware implementation for an apparatus 1905 employing a processing system 1910, in accordance with the present disclosure. The apparatus 1905 may be a base station .

The processing system 1910 may be implemented with a bus architecture, represented generally by the bus 1915. The bus 1915 may include any number of interconnecting buses and bridges depending on the specific application of the processing system 1910 and the overall design constraints. The bus 1915 links together various circuits including one or more processors and/or hardware components, represented by the processor 1920, the illustrated components, and the computer-readable medium / memory 1925. The bus 1915 may also link various other circuits, such as timing sources, peripherals, voltage regulators, power management circuits, and/or the like.

The processing system 1910 may be coupled to a transceiver 1930. The transceiver 1930 is coupled to one or more antennas 1935. The transceiver 1930 provides a means for communicating with various other apparatuses over a transmission medium. The transceiver 1930 receives a signal from the one or more antennas 1935, extracts information from the received signal, and provides the extracted information to the processing system 1910, specifically the reception component 1802. In addition, the transceiver 1930 receives information from the processing system 1910, specifically the transmission component 1806, and generates a signal to be applied to the one or more antennas 1935 based at least in part on the received information.

The processing system 1910 includes a processor 1920 coupled to a computer-readable medium / memory 1925. The processor 1920 is responsible for general processing, including the execution of software stored on the computer-readable medium / memory 1925. The software, when executed by the processor 1920, causes the processing system 1910 to perform the various functions described herein for any particular apparatus. The computer-readable medium / memory 1925 may also be used for storing data that is manipulated by the processor 1920 when executing software. The processing system further includes at least one of the illustrated components. The components may be software modules running in the processor 1920, resident/stored in the computer-readable medium / memory 1925, one or more hardware modules coupled to the processor 1920, or some combination thereof.

In some aspects, the processing system 1910 may be a component of the base station 110 and may include the memory 242 and/or at least one of the TX MIMO processor 230, the RX processor 238, and/or the controller/processor 240. In some aspects, the apparatus 1905 for wireless communication includes means for receiving an indication that a UE has a capability to operate as a layer 2 relay UE, means for transmitting a layer 2 relay initial configuration to the UE based at least in part on receiving the indication, and/or the like. The aforementioned means may be one or more of the aforementioned components of the apparatus 1800 and/or the processing system 1910 of the apparatus 1905 configured to perform the functions recited by the aforementioned means. As described elsewhere herein, the processing system 1910 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 19 is provided as an example. Other examples may differ from what is described in connection with FIG. 19.

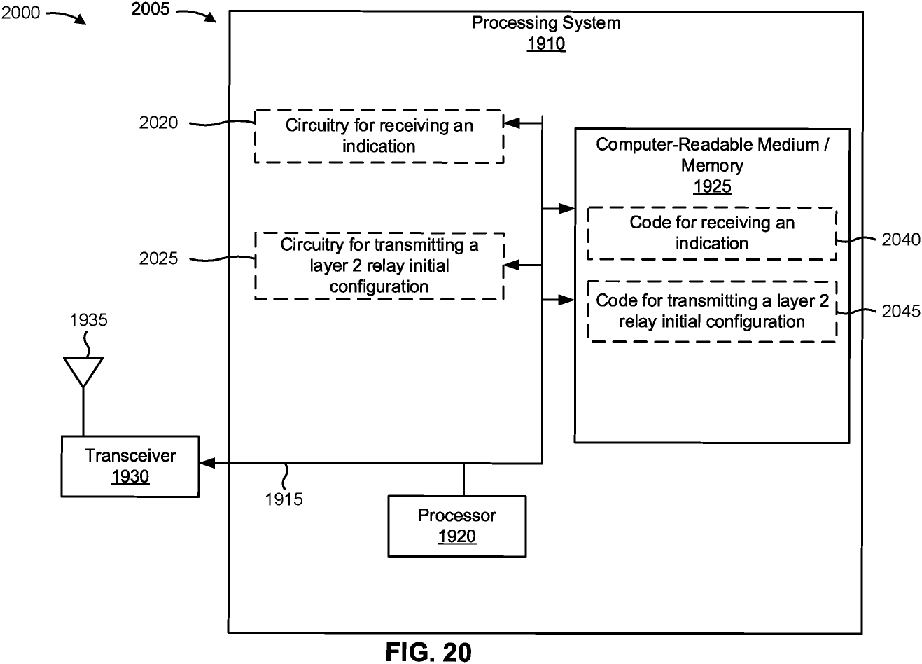

FIG. 20 is a diagram illustrating an example 2000 of an implementation of code and circuitry for an apparatus 2005, in accordance with the present disclosure. The apparatus 2005 may be a base station.

As shown in FIG. 20, the apparatus 2005 may include circuitry for receiving an indication (circuitry 2020). For example, the circuitry 2020 may provide means for receiving an indication that a UE has a capability to operate as a layer 2 relay UE.

As shown in FIG. 20, the apparatus 2005 may include circuitry for transmitting a layer 2 relay initial configuration (circuitry 2025). For example, the circuitry 2025 may provide means for transmitting a layer 2 relay initial configuration to the UE based at least in part on receiving the indication.

The circuitry 2020 and/or 2025 may include one or more components of the relay UE 120a described above in connection with FIG. 2, such as communication manager 150, transmit processor 220, TX MIMO processor 230, MOD 232, DEMOD 232, MIMO detector 236, receive processor 238, antenna 234, controller/processor 240, and/or memory 242.

As shown in FIG. 20, the apparatus 2005 may include, stored in computer-readable medium 1925, code for receiving an indication (code 2040). For example, the code 2040, when executed by the processor 1920, may cause the apparatus 2005 to receive an indication that a UE has a capability to operate as a layer 2 relay UE.

As shown in FIG. 20, the apparatus 2005 may include, stored in computer-readable medium 1925, code for transmitting a layer 2 relay initial configuration (code 2045). For example, the code 2045, when executed by the processor 1920, may cause the apparatus 2005 to transmit a layer 2 relay initial configuration to the UE based at least in part on receiving the indication.

FIG. 20 is provided as an example. Other examples may differ from what is described in connection with FIG. 20.

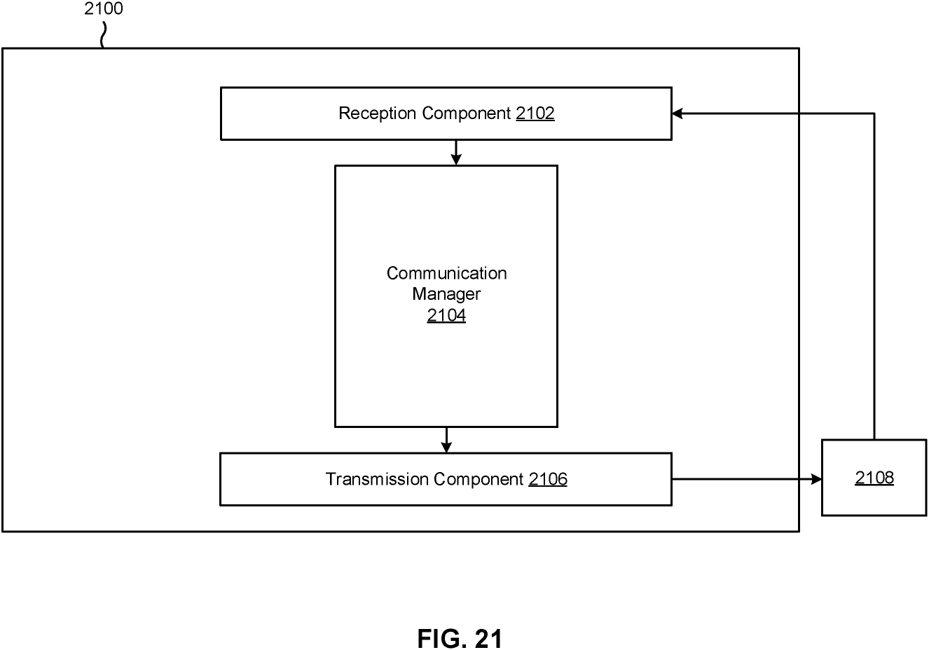

FIG. 21 is a block diagram of an example apparatus 2100 for wireless communication, in accordance with the present disclosure. The apparatus 2100 may be a remote UE (e.g., UE 120e, remote UE 305, remote UE 405, remote UE 505, remote UE 605, the remote UE described above in connection with FIGS. 7-10, and/or the like), or a remote UE may include the apparatus 2100. In some aspects, the apparatus 2100 includes a reception component 2102, a communication manager 2104, and a transmission component 2106, which may be in communication with one another (for example, via one or more buses). As shown, the apparatus 2100 may communicate with another apparatus 2108 (such as a UE (e.g., a relay UE), a base station, or another wireless communication device) using the reception component 2102 and the transmission component 2106.

In some aspects, the apparatus 2100 may be configured to perform one or more operations described herein in connection with FIGS. 7-10. Additionally, or alternatively, the apparatus 2100 may be configured to perform one or more processes described herein, such as process 1400 of FIG. 14 or a combination thereof. In some aspects, the apparatus 2100 may include one or more components of the remote UE (e.g., UE 120e) described above in connection with FIG. 2.

The reception component 2102 may receive communications, such as reference signals, control information, data communications, or a combination thereof, from the apparatus 2108. The reception component 2102 may provide received communications to one or more other components of the apparatus 2100, such as the communication manager 2104. In some aspects, the reception component 2102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 2102 may include one or more antennas, a demodulator, a MIMO detector, a receive processor, a controller/processor, a memory, or a combination thereof, of the remote UE described above in connection with FIG. 2.

The transmission component 2106 may transmit communications, such as reference signals, control information, data communications, or a combination thereof, to the apparatus 2108. In some aspects, the communication manager 2104 may generate communications and may transmit the generated communications to the transmission component 2106 for transmission to the apparatus 2108. In some aspects, the transmission component 2106 may perform signal processing on the generated communications (such as filtering, amplification, modulation, digital-to-analog conversion, multiplexing, interleaving, mapping, or encoding, among other examples), and may transmit the processed signals to the apparatus 2108. In some aspects, the transmission component 2106 may include one or more antennas, a modulator, a transmit MIMO processor, a transmit processor, a controller/processor, a memory, or a combination thereof, of the remote UE described above in connection with FIG. 2. In some aspects, the transmission component 2106 may be co-located with the reception component 2102 in a transceiver.

The communication manager 2104 may transmit (or may cause the transmission component 2106 to transmit) a request to establish a layer 2 relay service to the apparatus 2108. The communication manager 2104 may receive (or may cause the reception component 2102 to receive) a layer 2 relay initial configuration from the apparatus 2108 based at least in part on transmitting the request. In some aspects, the communication manager 2104 may include a controller/processor, a memory, or a combination thereof, of the remote UE (e.g., UE 120e) described above in connection with FIG. 2.

In some aspects, the communication manager 2104 may include a set of components. Alternatively, the set of components may be separate and distinct from the communication manager 2104. In some aspects, one or more components of the set of components may include or may be implemented within a controller/processor, a memory, or a combination thereof, of the remote UE (e.g., UE 120e) described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The number and arrangement of components shown in FIG. 21 are provided as an example. In practice, there may be additional components, fewer components, different components, or differently arranged components than those shown in FIG. 21. Furthermore, two or more components shown in FIG. 21 may be implemented within a single component, or a single component shown in FIG. 21 may be implemented as multiple, distributed components. Additionally, or alternatively, a set of (one or more) components shown in FIG. 21 may perform one or more functions described as being performed by another set of components shown in FIG. 21.

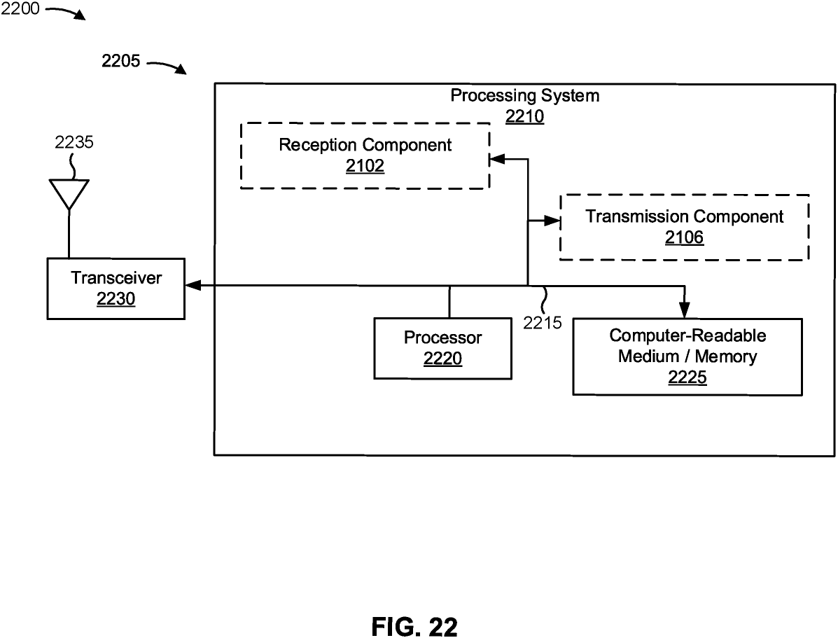

FIG. 22 is a diagram illustrating an example 2200 of a hardware implementation for an apparatus 2205 employing a processing system 2210, in accordance with the present disclosure. The apparatus 2205 may be a remote UE (e.g., UE 120e, remote UE 305, remote UE 405, remote UE 505, remote UE 605, the remote UE described above in connection with FIGS. 7-10, and/or the like).

The processing system 2210 may be implemented with a bus architecture, represented generally by the bus 2215. The bus 2215 may include any number of interconnecting buses and bridges depending on the specific application of the processing system 2210 and the overall design constraints. The bus 2215 links together various circuits including one or more processors and/or hardware components, represented by the processor 2220, the illustrated components, and the computer-readable medium / memory 2225. The bus 2215 may also link various other circuits, such as timing sources, peripherals, voltage regulators, power management circuits, and/or the like.

The processing system 2210 may be coupled to a transceiver 2230. The transceiver 2230 is coupled to one or more antennas 2235. The transceiver 2230 provides a means for communicating with various other apparatuses over a transmission medium. The transceiver 2230 receives a signal from the one or more antennas 2235, extracts information from the received signal, and provides the extracted information to the processing system 2210, specifically the reception component 2102. In addition, the transceiver 2230 receives information from the processing system 2210, specifically the transmission component 2106, and generates a signal to be applied to the one or more antennas 2235 based at least in part on the received information.

The processing system 2210 includes a processor 2220 coupled to a computer-readable medium / memory 2225. The processor 2220 is responsible for general processing, including the execution of software stored on the computer-readable medium / memory 2225. The software, when executed by the processor 2220, causes the processing system 2210 to perform the various functions described herein for any particular apparatus. The computer-readable medium / memory 2225 may also be used for storing data that is manipulated by the processor 2220 when executing software. The processing system further includes at least one of the illustrated components. The components may be software modules running in the processor 2220, resident/stored in the computer-readable medium / memory 2225, one or more hardware modules coupled to the processor 2220, or some combination thereof.

In some aspects, the processing system 2210 may be a component of the UE 120 and may include the memory 282 and/or at least one of the TX MIMO processor 266, the RX processor 258, and/or the controller/processor 280. In some aspects, the apparatus 2205 for wireless communication includes means for transmitting a request to establish a layer 2 relay service to a relay UE, means for receiving a layer 2 relay initial configuration from the relay UE based at least in part on transmitting the request, and/or the like. The aforementioned means may be one or more of the aforementioned components of the apparatus 2100 and/or the processing system 2210 of the apparatus 2205 configured to perform the functions recited by the aforementioned means. As described elsewhere herein, the processing system 2210 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 22 is provided as an example. Other examples may differ from what is described in connection with FIG. 22.

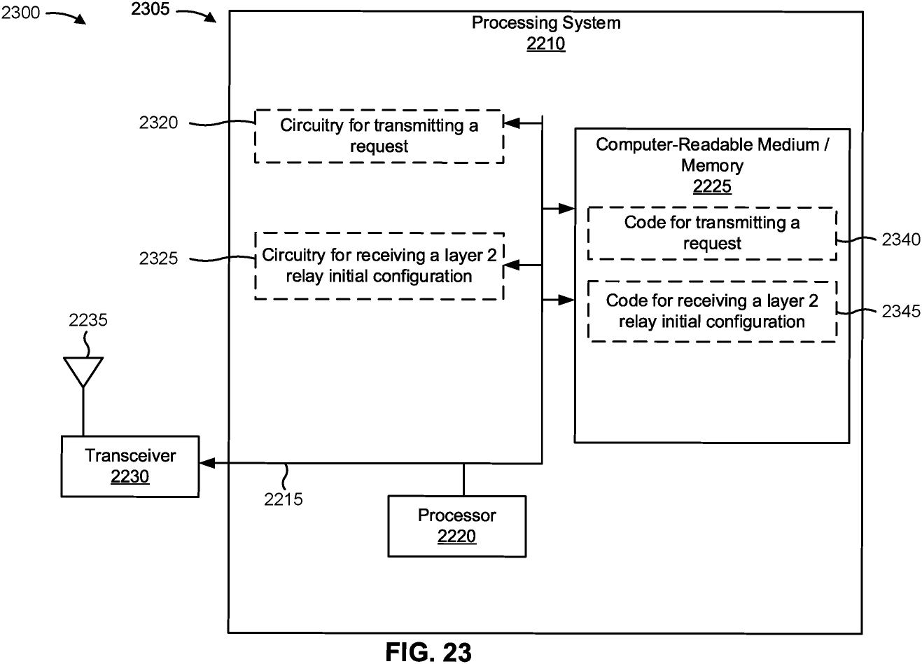

FIG. 23 is a diagram illustrating an example 2300 of an implementation of code and circuitry for an apparatus 2305, in accordance with the present disclosure. The apparatus 2305 may be a relay UE.

As shown in FIG. 23, the apparatus 2305 may include circuitry for transmitting a request (circuitry 2320). For example, the circuitry 2320 may provide means for transmitting a request to establish a layer 2 relay service to a relay UE.

As shown in FIG. 23, the apparatus 2305 may include circuitry for receiving a layer 2 relay initial configuration (circuitry 2325). For example, the circuitry 2325 may provide means for receiving a layer 2 relay initial configuration based at least in part on initiating the connection.

The circuitry 2320 and/or 2325 may include one or more components of the relay UE 120a described above in connection with FIG. 2, such as communication manager 140, transmit processor 264, TX MIMO processor 266, MOD 254, DEMOD 254, MIMO detector 256, receive processor 258, antenna 252, controller/processor 280, and/or memory 282.

As shown in FIG. 23, the apparatus 2305 may include, stored in computer-readable medium 2225, code for transmitting a request (code 2340). For example, the code 2340, when executed by the processor 2220, may cause the apparatus 2305 to transmit a request to establish a layer 2 relay service to a relay UE.

As shown in FIG. 23, the apparatus 2305 may include, stored in computer-readable medium 2225, code for receiving a layer 2 relay initial configuration (code 2345). For example, the code 2345, when executed by the processor 2220, may cause the apparatus 2305 to receive a layer 2 relay initial configuration from the relay UE based at least in part on transmitting the request.

FIG. 23 is provided as an example. Other examples may differ from what is described in connection with FIG. 23.

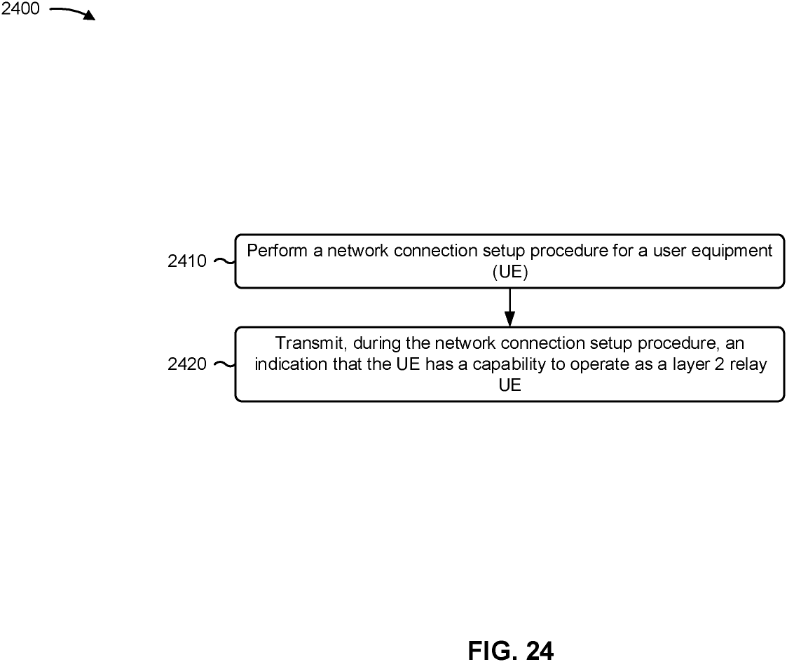

FIG. 24 is a diagram illustrating an example process 2400 performed, for example, by a network entity, in accordance with the present disclosure. Example process 2400 is an example where the network entity (e.g., base station 110, NG-RAN 340, NG-RAN 440, NG-RAN 540, NG-RAN 650, the NG-RAN illustrated and described above in connection with FIGS. 7-10, a network controller 130 (e.g., an SMF, an AMF, a UPF), and/or the like) performs operations associated with UE capability signaling.

As shown in FIG. 24, in some aspects, process 24 may include performing a network connection setup procedure for a UE (block 2410). For example, the network entity (e.g., using antenna 234, demodulator 232, MIMO detector 236, receive processor 238, controller/processor 240, memory 242, scheduler 246, controller/processor 290, memory 292, communication unit 294, reception component 2502, communication manager 2504, transmission component 2506, network connection component 2510, and/or the like) may perform a network connection setup procedure for a UE, as described herein.

As further shown in FIG. 24, in some aspects, process 2400 may include transmitting, during the network connection setup procedure, an indication that the UE has a capability to operate as a layer 2 relay UE (block 2420). For example, the network entity (e.g., using antenna 234, demodulator 232, MIMO detector 236, receive processor 238, controller/processor 240, memory 242, scheduler 246, controller/processor 290, memory 292, communication unit 294, reception component 2502, communication manager 2504, transmission component 2506, network connection component 2510, and/or the like) may transmit, during the network connection setup procedure, an indication that the UE has a capability to operate as a layer 2 relay UE as described above.

Process 2400 may include additional aspects, such as any single aspect or any combination of aspects described below and/or in connection with one or more other processes described elsewhere herein.

In a first aspect, performing the network connection setup procedure includes performing a registration procedure for the UE. In a second aspect, alone or in combination with the first aspect, performing the network connection setup procedure includes performing a service request procedure for the UE. In a third aspect, alone or in combination with one or more of the first and second aspects, the UE is configured to relay SRB0 traffic.

In a fourth aspect, process 2400 includes transmitting, during the network connection setup procedure, an indication of a UE context associated with the UE. In a fifth aspect, alone or in combination with one or more of the first through fourth aspects, transmitting the indication that the UE as a capability to operate as a layer 2 relay UE includes transmitting an indication of a layer 2 relay authorization for the UE. In a sixth aspect, alone or in combination with one or more of the first through fifth aspects, transmitting the indication that the UE as a capability to operate as a layer 2 relay UE includes transmitting, in an N2 message, the indication that the UE as a capability to operate as a layer 2 relay UE.

Although FIG. 24 shows example blocks of process 2400, in some aspects, process 2400 may include additional blocks, fewer blocks, different blocks, or differently arranged blocks than those depicted in FIG. 24. Additionally, or alternatively, two or more of the blocks of process 2400 may be performed in parallel.

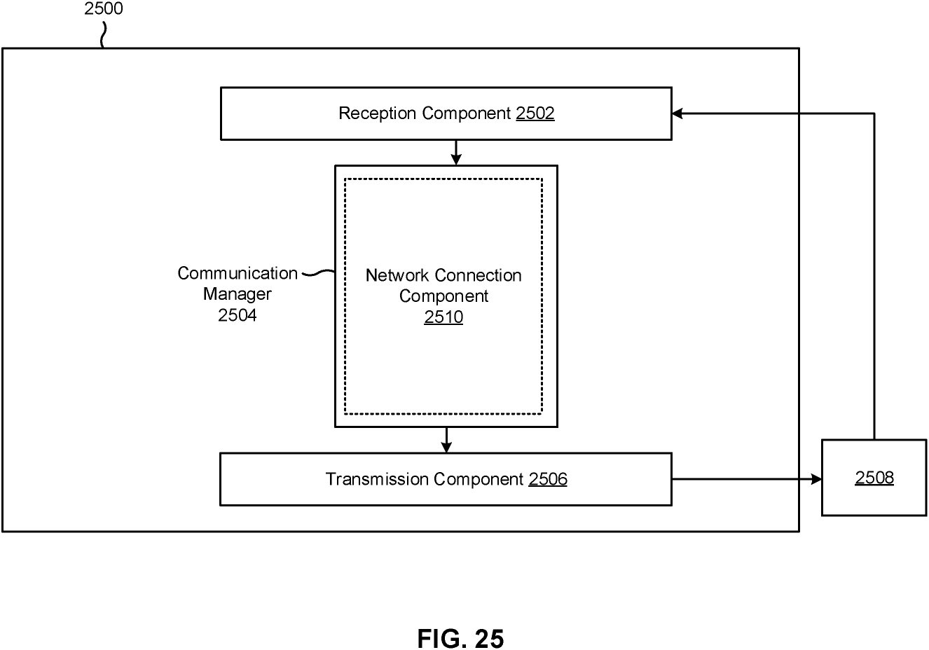

FIG. 25 is a block diagram of an example apparatus 2500 for wireless communication, in accordance with the present disclosure. The apparatus 2500 may be a network entity (e.g., a network controller 130, an SMF, a UPF, an AMF, and/or the like), or a network entity may include the apparatus 2500. In some aspects, the apparatus 2500 includes a reception component 2502, a communication manager 2504, and a transmission component 2506, which may be in communication with one another (for example, via one or more buses). As shown, the apparatus 2500 may communicate with another apparatus 2508 (such as a UE, a base station, or another wireless communication device) using the reception component 2502 and the transmission component 2506.

In some aspects, the apparatus 2500 may be configured to perform one or more operations described herein in connection with FIGS. 7-10. Additionally, or alternatively, the apparatus 2500 may be configured to perform one or more processes described herein, such as process 2400 of FIG. 24. In some aspects, the apparatus 2500 may include one or more components of the network controller 130 described above in connection with FIG. 2.

The reception component 2502 may receive communications, such as reference signals, control information, data communications, or a combination thereof, from the apparatus 2508. The reception component 2502 may provide received communications to one or more other components of the apparatus 2500, such as the communication manager 2504. In some aspects, the reception component 2502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 2502 may include one or more antennas, a demodulator, a MIMO detector, a receive processor, a controller/processor, a memory, or a combination thereof, of the network controller 130 described above in connection with FIG. 2.

The transmission component 2506 may transmit communications, such as reference signals, control information, data communications, or a combination thereof, to the apparatus 2508. In some aspects, the communication manager 2504 may generate communications and may transmit the generated communications to the transmission component 2506 for transmission to the apparatus 2508. In some aspects, the transmission component 2506 may perform signal processing on the generated communications (such as filtering, amplification, modulation, digital-to-analog conversion, multiplexing, interleaving, mapping, or encoding, among other examples), and may transmit the processed signals to the apparatus 2508. In some aspects, the transmission component 2506 may include one or more antennas, a modulator, a transmit MIMO processor, a transmit processor, a controller/processor, a memory, or a combination thereof, of the network controller 130 described above in connection with FIG. 2. In some aspects, the transmission component 2506 may be co-located with the reception component 2502 in a transceiver.

In some aspects, the communication manager 2504 may perform a network connection setup procedure for a UE 120. In some aspects, the communication manager 2504 may transmit (or may cause the transmission component 2506 to transmit) (e.g., to a base station 110) during the network connection setup procedure, an indication that the UE has a capability to operate as a layer 2 relay UE. In some aspects, the communication manager 2504 may include a controller/processor, a memory, or a combination thereof, of the network controller 130 described above in connection with FIG. 2

In some aspects, the communication manager 2504 may include one or more components, such as an network connection component 2510. Alternatively, the one or more components may be separate and distinct from the communication manager 2504. In some aspects, one or more components of the set of components may include or may be implemented within a controller/processor, a memory, or a combination thereof, of the network controller 130 described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component. The initiation component 2510 may initiate a connection with the apparatus 2508.

The number and arrangement of components shown in FIG. 25 are provided as an example. In practice, there may be additional components, fewer components, different components, or differently arranged components than those shown in FIG. 25. Furthermore, two or more components shown in FIG. 25 may be implemented within a single component, or a single component shown in FIG. 25 may be implemented as multiple, distributed components. Additionally, or alternatively, a set of (one or more) components shown in FIG. 25 may perform one or more functions described as being performed by another set of components shown in FIG. 25.

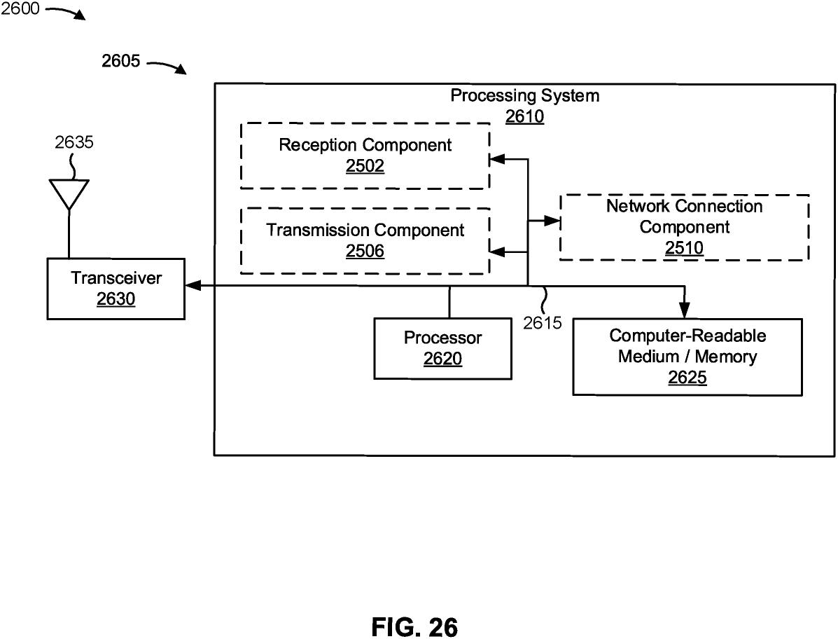

FIG. 26 is a diagram illustrating an example 2600 of a hardware implementation for an apparatus 2605 employing a processing system 2610, in accordance with the present disclosure. The apparatus 2605 may be a network controller 130.

The processing system 2610 may be implemented with a bus architecture, represented generally by the bus 2615. The bus 2615 may include any number of interconnecting buses and bridges depending on the specific application of the processing system 2610 and the overall design constraints. The bus 2615 links together various circuits including one or more processors and/or hardware components, represented by the processor 2620, the illustrated components, and the computer-readable medium / memory 2625. The bus 2615 may also link various other circuits, such as timing sources, peripherals, voltage regulators, power management circuits, and/or the like.

The processing system 2610 may be coupled to a transceiver 2630. The transceiver 2630 is coupled to one or more antennas 2635. The transceiver 2630 provides a means for communicating with various other apparatuses over a transmission medium. The transceiver 2630 receives a signal from the one or more antennas 2635, extracts information from the received signal, and provides the extracted information to the processing system 2610, specifically the reception component 2502. In addition, the transceiver 2630 receives information from the processing system 2610, specifically the transmission component 2506, and generates a signal to be applied to the one or more antennas 2635 based at least in part on the received information.

The processing system 2610 includes a processor 2620 coupled to a computer-readable medium / memory 2625. The processor 2620 is responsible for general processing, including the execution of software stored on the computer-readable medium / memory 2625. The software, when executed by the processor 2620, causes the processing system 2610 to perform the various functions described herein for any particular apparatus. The computer-readable medium / memory 2625 may also be used for storing data that is manipulated by the processor 2620 when executing software. The processing system further includes at least one of the illustrated components. The components may be software modules running in the processor 2620, resident/stored in the computer-readable medium / memory 2625, one or more hardware modules coupled to the processor 2620, or some combination thereof.

In some aspects, the processing system 2610 may be a component of a network controller 130, and may include one or more of a controller/processor 290, a memory 292, and/or a communication unit 294. In some aspects, the apparatus 2605 for wireless communication includes means for performing a network connection setup procedure for a UE. In some aspects, the apparatus 2605 for wireless communication may include means for means for transmitting, during the network connection setup procedure, an indication that the UE has a capability to operate as a layer 2 relay UE. The aforementioned means may be one or more of the aforementioned components of the apparatus 2500 and/or the processing system 2610 of the apparatus 2605 configured to perform the functions recited by the aforementioned means. As described elsewhere herein, the processing system 2610 may include one or more of a controller/processor 290, a memory 292, and/or a communication unit 294. In one configuration, the aforementioned means may be the one or more of a controller/processor 290, a memory 292, and/or a communication unit 294 configured to perform the functions and/or operations recited herein.

FIG. 26 is provided as an example. Other examples may differ from what is described in connection with FIG. 26.

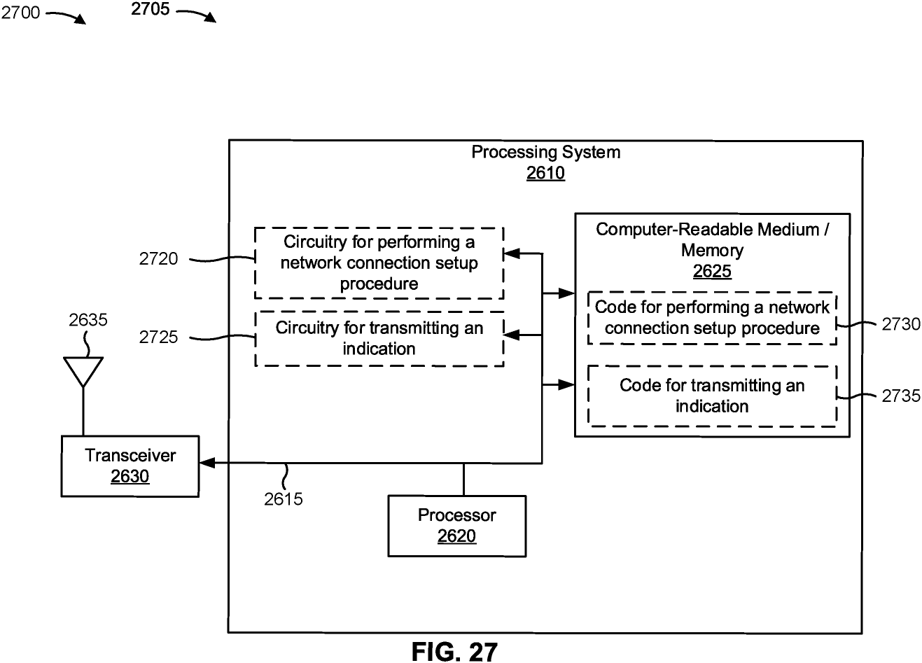

FIG. 27 is a diagram illustrating an example 2700 of an implementation of code and circuitry for an apparatus 2705, in accordance with the present disclosure. The apparatus 2705 may be a network controller 130.

As shown in FIG. 27, the apparatus 2705 may include circuitry for performing a network connection setup procedure (circuitry 2720). For example, the circuitry 2720 may provide means for performing a network connection setup procedure for a UE.

As shown in FIG. 27, the apparatus 2705 may include circuitry for transmitting an indication (circuitry 2725). For example, the circuitry 2725 may provide means for transmitting, during the network connection setup procedure, an indication that the UE has a capability to operate as a layer 2 relay UE.

The circuitry 2720 and/or 2725 may include one or more components of the network controller 130 described above in connection with FIG. 2, such as controller/processor 290, a memory 292, and/or a communication unit 294.

As shown in FIG. 27, the apparatus 2705 may include, stored in computer-readable medium 2625, code for performing a network connection setup procedure (code 2730). For example, the code 2730, when executed by the processor 2620, may cause the apparatus 2705 to performing a network connection setup procedure for a UE.

As shown in FIG. 27, the apparatus 2705 may include, stored in computer-readable medium 2625, code for transmitting an indication (code 2735). For example, the code 2735, when executed by the processor 2620, may cause the apparatus 2705 to transmit, during the network connection setup procedure, an indication that the UE has a capability to operate as a layer 2 relay UE.

FIG. 27 is provided as an example. Other examples may differ from what is described in connection with FIG. 27.

The following provides an overview of some Aspects of the present disclosure:

Aspect 1: A method, of wireless communication performed by a network entity component, comprising: performing a network connection setup procedure for a user equipment (UE); and transmitting, during the network connection setup procedure, an indication that the UE has a capability to operate as a layer 2 relay UE.

Aspect 2: The method of Aspect 1, wherein performing the network connection setup procedure comprises: performing a registration procedure for the UE.

Aspect 3: The method of Aspect 1 or 2, wherein performing the network connection setup procedure comprises performing a service request procedure for the UE.

Aspect 4: The method of any of Aspects 1-3, wherein the UE is configured to relay signaling radio bearer zero (SRB0) traffic.

Aspect 5: The method of any of Aspects 1-4, further comprising: transmitting, during the network connection setup procedure, an indication of a UE context associated with the UE.

Aspect 6: The method of any of Aspects 1-5, wherein transmitting the indication that the UE as a capability to operate as a layer 2 relay UE comprises: transmitting an indication of a layer 2 relay authorization for the UE.

Aspect 7: The method of any of Aspects 1-6, wherein transmitting the indication that the UE as a capability to operate as a layer 2 relay UE comprises: transmitting, in an N2 message, the indication that the UE as a capability to operate as a layer 2 relay UE.

Aspect 8: A method of wireless communication performed by a relay user equipment (UE), comprising: initiating a connection with a network entity; and receiving a layer 2 relay initial configuration based at least in part on initiating the connection.

Aspect 9: The method of Aspect 8, wherein initiating the connection with the network entity comprises at least one of: performing a successful authentication and security set up with the network entity during a non-access stratum (NAS) registration and service request procedure, or performing a successful access stratum (AS) security setup with the network entity during radio resource control (RRC) connection setup procedure.

Aspect 10: The method of Aspect 8 or 9, wherein receiving the layer 2 relay initial configuration comprises: receiving the layer 2 relay initial configuration in a radio resource control (RRC) reconfiguration message from the network entity.

Aspect 11: The method of any of Aspects 8-10, wherein the layer 2 relay initial configuration includes at least one of, an access link radio link control (RLC) channel configuration for remote UE access link signaling radio bearer (SRB) traffic relaying, an adaptation configuration for an SRB for access link RLC channel and local connection channel mapping, or a local connection channel configuration for remote UE sidelink SRB traffic relaying.

Aspect 12: The method of Aspect 11, wherein the access link RLC channel and local connection channel configuration includes at least one of: an RLC entity configuration, a medium access control (MAC) logical channel configuration, or a physical (PHY) layer configuration.

Aspect 13: The method of any of Aspects 8-12, further comprising: receiving a request to establish a layer 2 relay service from a second UE over a local connection, wherein the local connection includes at least one of a sidelink, a WiFi link, WiFi direct (WiFi-D) link, a Bluetooth (BT) link, or a Bluetooth low energy (BTLE) link; and transmitting the layer 2 relay initial configuration to the remote UE based at least in part on receiving the request.

Aspect 14: The method of Aspect 13, wherein transmitting the layer 2 relay initial configuration to the first UE comprises: transmitting the layer 2 relay initial configuration to the first UE in a sidelink message indicating that set up of a sidelink unicast link between the first UE and the second UE was successful.

Aspect 15: The method of Aspects 13 or 14, wherein transmitting the layer 2 relay initial configuration to the remote UE comprises: transmitting the layer 2 relay initial configuration to the remote UE in a PC5-radio resource control (PC5-RRC) message.

Aspect 16: The method of any of Aspects 13-15, wherein the layer 2 relay initial configuration includes a local connection radio link control (RLC) channel configuration for relaying signaling radio bearer zero (SRB0) traffic between the remote UE and a network entity.

Aspect 17: The method of any of Aspects 13-16, further comprising: receiving a signaling radio bearer 0 (SRB0) radio resource control (RRC) setup request from the remote UE; and relaying the SRB0 RRC setup request to a network entity based at least in part on the layer 2 relay initial configuration.

Aspect 18: The method of Aspect 17, further comprising: receiving an RRC setup message from the network entity; and relaying the RRC setup message to the remote UE based at least in part on the layer 2 relay initial configuration.

Aspect 19: A method of wireless communication performed by a network entity, comprising: receiving an indication that a user equipment (UE) has a capability to operate as a layer 2 relay UE; and transmitting a layer 2 relay initial configuration to the UE based at least in part on receiving the indication.

Aspect 20: The method of Aspect 19, wherein receiving the indication comprises: receiving the indication from another network entity based on successful UE authentication and security setup.

Aspect 21: The method of Aspect 19 or 20, wherein receiving the indication comprises: receiving the indication in an N2 message during a non-access stratum (NAS) registration and service request procedure.

Aspect 22: The method of any of Aspects 19-20, wherein transmitting the layer 2 relay initial configuration comprises: transmitting the layer 2 relay initial configuration in a radio resource control (RRC) reconfiguration message.

Aspect 23: The method of any of Aspects 19-22, wherein the layer 2 relay initial configuration includes at least one of, an access link radio link control (RLC) channel configuration for remote UE access link signaling radio bearer (SRB) traffic relaying, an adaptation configuration for an SRB for access link RLC channel and sidelink RLC channel mapping, or a sidelink RLC channel configuration for remote UE sidelink SRB traffic relaying.

Aspect 24: The method of Aspect 23, wherein the access link RLC channel and local connection configuration includes at least one of: an RLC entity configuration, a medium access control (MAC) logical channel configuration, or a physical (PHY) layer configuration.

Aspect 25: The method of any of Aspects 19-24, wherein the layer 2 relay initial configuration is associated with a signaling radio bearer zero (SRB0).

Aspect 26: A method of wireless communication performed by a first user equipment (UE), comprising: receiving a request to establish a layer 2 relay service from a second UE; and transmitting a layer 2 relay initial configuration to the second UE based at least in part on receiving the request.

Aspect 27: The method of Aspect 26, wherein transmitting the layer 2 relay initial configuration to the second UE comprises: transmitting the layer 2 relay initial configuration to the second UE in a sidelink message indicating that set up of a local connection unicast link between the second UE and the first UE was successful.

Aspect 28: The method of Aspect 26 or 27, wherein transmitting the layer 2 relay initial configuration to the second UE comprises: transmitting the layer 2 relay initial configuration to the second UE in a sidelink message.

Aspect 29: The method of any of Aspects 26-28, wherein the layer 2 relay initial configuration includes a sidelink radio link control (RLC) channel configuration for relaying signaling radio bearer (SRB) traffic between the second UE and a base station.

Aspect 30: The method of any of Aspects 26-29, further comprising: receiving a signaling radio bearer 0 (SRB0) radio resource control (RRC) setup request from the second UE; and relaying the SRB0 RRC setup request to a network entity based at least in part on the layer 2 relay initial configuration.

Aspect 31: The method of Aspect 30, further comprising: receiving an RRC setup message from the network entity; and relaying the RRC setup message to the second UE based at least in part on the layer 2 relay initial configuration.

Aspect 32: A method of wireless communication performed by a first user equipment (UE), comprising: transmitting a request to establish a layer 2 relay service to a second UE; and receiving a layer 2 relay initial configuration from the second UE based at least in part on transmitting the request.

Aspect 33: The method of Aspect 32, wherein receiving the layer 2 relay initial configuration from the second UE comprises: receiving the layer 2 relay initial configuration from the second UE in a PC5-S message indicating that set up of a PC5 unicast link between the first UE and the second UE was successful.

Aspect 34: The method of Aspect 32 or 33, wherein receiving the layer 2 relay initial configuration from the second UE comprises: receiving the layer 2 relay initial configuration from the second UE in a PC5-radio resource control X(PC5-RRC) message.

Aspect 35: The method of any of Aspects 32-34, wherein the layer 2 relay initial configuration includes a sidelink radio link control (RLC) channel configuration for relaying signaling radio bearer (SRB) traffic between the second UE and a network entity.

Aspect 36: The method of any of Aspects 32-35, further comprising: initiating a radio resource control (RRC) connection with a base station via the second UE based at least in part on the layer 2 relay initial configuration.

Aspect 37: An apparatus for wireless communication at a device, comprising a processor; memory coupled with the processor; and instructions stored in the memory and executable by the processor to cause the apparatus to perform the method of one or more of Aspects 1-7.

Aspect 38: A device for wireless communication, comprising a one or more processors coupled to the memory, the memory and the one or more processors configured to perform the method of one or more of Aspects 1-7.

Aspect 39: An apparatus for wireless communication, comprising at least one means for performing the method of one or more of Aspects 1-7.

Aspect 40: A non-transitory computer-readable medium storing code for wireless communication, the code comprising instructions executable by a processor to perform the method of one or more of Aspects 1-7.

Aspect 41: A non-transitory computer-readable medium storing a set of instructions for wireless communication, the set of instructions comprising one or more instructions that, when executed by one or more processors of a device, cause the device to perform the method of one or more of Aspects 1-7.

Aspect 42: An apparatus for wireless communication at a device, comprising a processor; memory coupled with the processor; and instructions stored in the memory and executable by the processor to cause the apparatus to perform the method of one or more of Aspects 8-18.

Aspect 43: A device for wireless communication, comprising a memory and one or more processors coupled to the memory, the memory and the memory and the one or more processors configured to perform the method of one or more of Aspects 8-18.

Aspect 44: An apparatus for wireless communication, comprising at least one means for performing the method of one or more of Aspects 8-18.

Aspect 45: A non-transitory computer-readable medium storing code for wireless communication, the code comprising instructions executable by a processor to perform the method of one or more of Aspects 8-18.

Aspect 46: A non-transitory computer-readable medium storing a set of instructions for wireless communication, the set of instructions comprising one or more instructions that, when executed by one or more processors of a device, cause the device to perform the method of one or more of Aspects 8-18.

Aspect 47: An apparatus for wireless communication at a device, comprising a processor; memory coupled with the processor; and instructions stored in the memory and executable by the processor to cause the apparatus to perform the method of one or more of Aspects 19-25.

Aspect 48: A device for wireless communication, comprising a memory and one or more processors coupled to the memory, the memory and the one or more processors configured to perform the method of one or more of Aspects 19-25.

Aspect 49: An apparatus for wireless communication, comprising at least one means for performing the method of one or more of Aspects 19-25.

Aspect 50: A non-transitory computer-readable medium storing code for wireless communication, the code comprising instructions executable by a processor to perform the method of one or more of Aspects 19-25.

Aspect 51: A non-transitory computer-readable medium storing a set of instructions for wireless communication, the set of instructions comprising one or more instructions that, when executed by one or more processors of a device, cause the device to perform the method of one or more of Aspects 19-25.

Aspect 52: An apparatus for wireless communication at a device, comprising a processor; memory coupled with the processor; and instructions stored in the memory and executable by the processor to cause the apparatus to perform the method of one or more of Aspects 26-31.

Aspect 53: A device for wireless communication, comprising a memory and one or more processors coupled to the memory, the memory and the one or more processors configured to perform the method of one or more of Aspects 26-31.

Aspect 54: An apparatus for wireless communication, comprising at least one means for performing the method of one or more of Aspects 26-31.

Aspect 55: A non-transitory computer-readable medium storing code for wireless communication, the code comprising instructions executable by a processor to perform the method of one or more of Aspects 26-31.

Aspect 56: A non-transitory computer-readable medium storing a set of instructions for wireless communication, the set of instructions comprising one or more instructions that, when executed by one or more processors of a device, cause the device to perform the method of one or more of Aspects 26-31.

Aspect 57: An apparatus for wireless communication at a device, comprising a processor; memory coupled with the processor; and instructions stored in the memory and executable by the processor to cause the apparatus to perform the method of one or more of Aspects 32-36.

Aspect 58: A device for wireless communication, comprising a memory and one or more processors coupled to the memory, the memory and the one or more processors configured to perform the method of one or more of Aspects 32-36.

Aspect 59: An apparatus for wireless communication, comprising at least one means for performing the method of one or more of Aspects 32-36.

Aspect 60: A non-transitory computer-readable medium storing code for wireless communication, the code comprising instructions executable by a processor to perform the method of one or more of Aspects 32-36.

Aspect 61: A non-transitory computer-readable medium storing a set of instructions for wireless communication, the set of instructions comprising one or more instructions that, when executed by one or more processors of a device, cause the device to perform the method of one or more of Aspects 32-36.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, of wireless communication performed by a network entity component, comprising:
performing a network connection setup procedure for a user equipment (UE); and
transmitting, during the network connection setup procedure, an indication that the UE has a capability to operate as a layer 2 relay UE.

2. The method of claim 1, wherein performing the network connection setup procedure comprises:
performing a registration procedure for the UE.

3. The method of claim 1, wherein performing the network connection setup procedure comprises
performing a service request procedure for the UE.

4. The method of claim 1, wherein the UE is configured to relay signaling radio bearer zero (SRB0) traffic.

5. The method of claim 1, further comprising:
transmitting, during the network connection setup procedure, an indication of a UE context associated with the UE.

6. The method of claim 1, wherein transmitting the indication that the UE has a capability to operate as a layer 2 relay UE comprises:
transmitting an indication of a layer 2 relay authorization for the UE.

7. The method of claim 1, wherein transmitting the indication that the UE has a capability to operate as a layer 2 relay UE comprises:
transmitting, in an N2 message, the indication that the UE has a capability to operate as a layer 2 relay UE.

8. A method of wireless communication performed by a first user equipment (UE), comprising:
initiating a connection with a network entity; and
receiving a layer 2 relay initial configuration based at least in part on initiating the connection.

9. The method of claim 8, wherein initiating the connection with the network entity comprises at least one of:
performing a successful authentication and security set up with the network entity during a non-access stratum (NAS) registration and service request procedure, or
performing a successful access stratum (AS) security setup with the network entity during radio resource control (RRC) connection setup procedure.

10. The method of claim 8, wherein receiving the layer 2 relay initial configuration comprises:
receiving the layer 2 relay initial configuration in a radio resource control (RRC) reconfiguration message from the network entity.

11. The method of claim 8, wherein the layer 2 relay initial configuration includes at least one of,
an access link radio link control (RLC) channel configuration for remote UE access link signaling radio bearer (SRB) traffic relaying,
an adaptation layer configuration for an SRB for access link RLC channel and local connection channel mapping, or
a local connection channel configuration for remote UE sidelink SRB traffic relaying.

12. The method of claim 11, wherein the access link RLC channel and local connection channel configuration includes at least one of:
an RLC entity configuration,
a medium access control (MAC) logical channel configuration, or
a physical (PHY) layer configuration.

13. The method of claim 8, further comprising:
receiving a request to establish a layer 2 relay service from a second UE over a local connection,
wherein the local connection includes at least one of a sidelink, a WiFi link, WiFi direct (WiFi-D) link, a Bluetooth (BT) link, or a Bluetooth low energy (BTLE) link; and
transmitting the layer 2 relay initial configuration to the second UE based at least in part on receiving the request.

14. The method of claim 13, wherein transmitting the layer 2 relay initial configuration to the second UE comprises:
transmitting the layer 2 relay initial configuration to the second UE in a sidelink message indicating that set up of a sidelink unicast link between the second UE and the first UE was successful.

15. The method of claim 13, wherein transmitting the layer 2 relay initial configuration to the second UE comprises:
transmitting the layer 2 relay initial configuration to the second UE in a PCS-radio resource control (PCS-RRC) message.

16. The method of claim 13, wherein the layer 2 relay initial configuration includes a local connection (RLC) channel configuration for relaying signaling radio bearer zero (SRBO) traffic between the second UE and anetwork entity.

17. The method of claim 13, further comprising:
receiving a signaling radio bearer 0 (SRB0) radio resource control (RRC) setup request from the second UE; and
relaying the SRB0 RRC setup request to a network entity based at least in part on the layer 2 relay initial configuration.

18. The method of claim 17, further comprising:
receiving an RRC setup message from the network entity; and
relaying the RRC setup message to the second UE based at least in part on the layer 2 relay initial configuration.

19. A method of wireless communication performed by a network entity, comprising:
receiving an indication that a user equipment (UE) has a capability to operate as a layer 2 relay UE; and
transmitting a layer 2 relay initial configuration to the UE based at least in part on receiving the indication.

20. The method of claim 19, wherein receiving the indication comprises:
receiving the indication from another network entity based on successful UE authentication and security setup.

21. The method of claim 19, wherein receiving the indication comprises:
receiving the indication in an N2 message during a non-access stratum (NAS) registration and service request procedure.

22. The method of claim 19, wherein transmitting the layer 2 relay initial configuration comprises:
transmitting the layer 2 relay initial configuration in a radio resource control (RRC) reconfiguration message.

23. The method of claim 19, wherein the layer 2 relay initial configuration includes at least one of,
an access link radio link control (RLC) channel configuration for second UE access link signaling radio bearer (SRB) traffic relaying,
an adaptation configuration for an SRB for access link RLC channel and local connection channel mapping, or
a local connection channel configuration for second UE sidelink SRB traffic relaying.

24. The method of claim 23, wherein the access link RLC and local connection channel configuration includes at least one of:
an RLC entity configuration,
a medium access control (MAC) logical channel configuration, or
a physical (PHY) layer configuration.

25. The method of claim 19, wherein the layer 2 relay initial configuration is associated with a signaling radio bearer zero (SRB0).

26. A method of wireless communication performed by a first user equipment (UE), comprising:
transmitting a request to establish a layer 2 relay service to a second UE; and
receiving a layer 2 relay initial configuration from the second UE based at least in part on transmitting the request.

27. The method of claim 26, wherein receiving the layer 2 relay initial configuration from the relay UE comprises:
receiving the layer 2 relay initial configuration from the second UE in a sidelink message indicating that set up of a local connection unicast link between the first UE and the second UE was successful.

28. The method of claim 26, wherein receiving the layer 2 relay initial configuration from the second UE comprises:
receiving the layer 2 relay initial configuration from the second UE in a sidelink message.

29. The method of claim 26, wherein the layer 2 relay initial configuration includes a sidelink radio link control (RLC) channel configuration for relaying signaling radio bearer (SRB) traffic between the first UE and a network entity.

30. The method of claim 26, further comprising:
initiating a radio resource control (RRC) connection with a base station via the second UE based at least in part on the layer 2 relay initial configuration.
